(19) United States
(12) Patent Application Publication
(10) Pub. No.: US 2026/0046330 A1
(43) Pub. Date: Feb. 12, 2026

(54) TRUST-AWARE DECENTRALIZED RESOURCE PROVISIONING FOR 6G TASK ASSIGNMENT

(71) Applicant: InterDigital Patent Holdings, Inc., Wilmington, DE (US)

(72) Inventors: Xu Li, Plainsboro, NJ (US); Chonggang Wang, Princeton, NJ (US); Robert Gazda, Spring City, PA (US); Ulises Olvera-Hernandez, Saint-Lazare (CA); Samir Ferdi, Kirkland (CA); Rocco Di Girolamo, Laval (CA)

(73) Assignee: InterDigital Patent Holdings, Inc., Wilmington, DE (US)

(21) Appl. No.: 18/799,596

(22) Filed: Aug. 9, 2024

(51) Int. Cl. H04L 67/1001

(52) U.S. Cl. CPC H04L 67/1001

(57) ABSTRACT

In some implementations, a first entity may receive, from a second entity, a task assignment request including one or more of: an identifier of a first task, identifier of the first and second entity, execution instructions, set of trust evaluation criteria, a first smart contract, a specified trust level, a drafted first smart contract, and a preferred. The first entity may analyze requirements for executing the first task, decide on resource requirements for executing the first task and accept, conditionally accept, or reject the request based on the resource requirements and the set of trust evaluation criteria. The first entity may send a modified first smart contract when the first smart contract is conditionally accepted. The first entity may receive a notification that the first smart contract or modified first smart contract is recorded in a distributed ledger system via a DLS and may execute a first task accepted/conditionally accepted.

### BACKGROUND

The sixth generation of wireless networks aims to provide ultra-low latency, high reliability, and massive connectivity, supporting applications like IoT, smart cities and autonomous systems. In 6G networks, resources, such as computing power and bandwidth, need to be allocated without centralized control to enable scalability and robustness. Trust management is essential for ensuring that the entities involved in task assignment and execution are reliable and perform as expected. Trust-aware mechanisms incorporate trust evaluation into resource provisioning process. Thus, the need exists for techniques addressing issues of trust and decentralization while efficiently assigning tasks in dynamic environments.

### SUMMARY

In one general aspect, a method, implemented in a first entity may, include receiving a task assignment request from a second entity where the task assignment request includes one or more of: an identifier of a first task, an identifier of the second entity, an identifier of the first entity, execution instructions, set of trust evaluation criteria adopted, a first smart contract, an expected trust level specified by the second entity, a drafted first smart contract, and a preferred distributed ledger service (DLS). The method may also include analyzing requirements for executing the first task based on the task assignment request. The method may furthermore include deciding on or determining resource requirements for executing the first task based on the analyzed requirements. The method may in addition include sending an acknowledgement (ACK) that the first task is conditionally accepted, accepted, or rejected based on the resource requirements and the set of trust evaluation criteria, where the ACK includes an indication that the first smart contract is accepted. The method may moreover include sending a modified first smart contract when the first smart contract is conditionally accepted. The method may also include receiving a notification that the first smart contract or the modified first smart contract is recorded in a distributed ledger service system. The method may include executing the first task when the first task is or accepted or is conditionally accepted. Other embodiments of this aspect include corresponding computer systems, apparatus, and computer programs recorded on one or more computer storage devices, each configured to perform the actions of the methods.

Implementations may include one or more of the following features. The method may include confirming a validation status of the first smart contract with a distributed ledger service (DLS) prior to executing the first task. The method where the instructions for executing the first task include one or more of: a first task identifier, a generic operation type (GOT), a GOT subtype, first task execution guidelines, description of the first task complexity, an indication of whether the first task can be stopped and replaced while the first task is being executed, and first task execution triggers. The method where the set of trust evaluation criteria specifies one or more: types of trust indicators considered, algorithms adopted for calculating respective types of trust indicators and a corresponding trust index, and parameter value configurations. The method may include analyzing terms of the first smart contract, where the terms of the first smart contract include one or more of: an identifier of the first task, an identifier of the second entity, a corresponding distributed ledger account and/or address of the second entity, and identifier of the first entity, a corresponding distributed ledger account and/or address of the first entity, specific execution instructions for the first task, a set trust evaluation criteria adopted, the expected trust level specified by the second entity, and clauses, terms, policies of the first smart contract. The method may include determining there are insufficient resources for executing the first task; identifying one or more ongoing second tasks corresponding to a second smart contract with a third entity that may be replaced by the first task; sending a task replacement proposal to the second entity; receiving a task replacement notification from the third entity, the task replacement indicating that a third smart contract is established between the second entity and the third entity; requesting, from the DLS, a validation that the second smart contract is terminated and the third smart is in effect; confirming the task replacement with the second entity and sending an updated first smart contract to the second entity; receiving an ACK from the second entity confirming task replacement; sending a finalized first smart contract to the DLS for recording; receiving, from the DLS, an ACK that the finalized first smart contract is recorded; and ending the second task with the third entity and performing the first task with the second entity using resources previously-allocated to second task. The method where the third entity is an UE, WTRU, network element, smart device, or IoT device hosting a software application or storing executable instructions which cause a specific task to be performed. The method may include determining the first task should be migrated to a fourth entity; sending a task migration alert to the second entity; receiving an ACK of the task migration alert; receiving, from the second entity, a request to migrate the first task to the fourth entity; and migrating the first task to the fourth entity. The method where the fourth entity is an UE, WTRU, network element, smart device, or IoT device hosting a software application or storing executable instructions which cause a specific task to be performed. The method where first entity is a wireless transmit/receive unit (WTRU), a network element, a smart device, or an internet of things (IoT) device, and where the second entity is an UE, WTRU, network element, smart device, or IoT device hosting a software application or storing executable instructions which cause a specific task to be performed. Implementations of the described techniques may include hardware, a method or process, or a computer tangible medium.

In another general aspect, a method, implemented in a second entity, may include generating task execution instructions for a first task. The method may also include determining at least one of a set of trust evaluation criteria and an expected trust level to be achieved. The method may furthermore include sending a first task assignment request to a first entity, the first task assignment including one or more of: an identifier of the first task, an identifier of the first entity, an identifier of the second entity, the execution instructions for the first task, a set of trust evaluation criteria adopted, a trust level specified by the second entity, a first smart contract, and a preferred DLS. The method may in addition include receiving an acknowledgement (ACK) from the first entity that the first task is accepted, conditionally accepted, or rejected. The method may moreover include sending a trust evaluation request to a TES to evaluate a trust of the first entity to perform at least the first task when the first task is conditionally accepted or accepted. Method may also include receiving an ACK from the TES, the ACK including a trust index. Method may furthermore include deciding to allow the first entity to continue execution of the first task or to terminate execution of the first task based on the trust index. Other embodiments of this aspect include corresponding computer systems, apparatus, and computer programs recorded on one or more computer storage devices, each configured to perform the actions of the methods.

Implementations may include one or more of the following features. The method may include: sending a first smart contract deployment request to a DLS including a finalized first smart contract when the first entity and the second entity agree to the finalized first smart contract; receiving an ACK from the DLS; and sending, to the first entity a notification indicating a successful recording of the first smart contract. The method where the first smart contract includes one or more of: an identifier of the first task, an identifier of the second entity, a corresponding distributed ledger account and/or address of the second entity, and identifier of the first entity, a corresponding distributed ledger account and/or address of the first entity, specific task instructions for the first task, a set trust evaluation criteria adopted, a trust level specified by the second entity, and clauses, terms, and policies specified for the first task. The method may include: receiving a task replacement proposal request from the first entity when the first entity is executing a second task with a third entity, has a second smart contract corresponding to the second task stored in the DLS, and does not have sufficient resources for the execution of the first task or continued execution of the first task; deciding to establish a task replacement with the third entity; generating a third smart contract to replace the second task with the first task; sending a task replacement initiation request including the third smart contract to the third entity; receiving, from the third entity, an ACK of the task replacement initiation request and an agreement to accept the task replacement; and receiving, from the first entity, a notification of task replacement complete. The method may include: receiving a task migration request from the first entity when determining it cannot provide sufficient resources for the first task; sending an ACK of the task migration request; sending a migration destination entity identification request to a third entity; receiving a list of destination entity candidates from the third entity; selecting a fourth entity from the list of destination entity candidates to migrate the first task; sending a request to the fourth entity to accept the migration of the first task; and sending a migration request to the first entity to migrate the first task to the fourth entity after the fourth entity agrees to accept the migration of the first task. The method where the first task execution instructions include one or more of: a first task identifier, at least one generic operation type (GOT), at least one GOT subtype, execution guidelines, a description of task complexity, an indication of whether a task can be stopped and replaced while a first entity is executing a task, and task execution triggers. The method where the set of trust evaluation criteria specifies one or more of: type of trust indicator (TIDC) for performing the first task, algorithms adopted for calculating a trust index (TIndex) of respective type of TIDC and a specified trust level. The method where the first entity is a wireless transmit/receive unit (WTRU), a network element, a smart device, or an internet of things (IoT) device. The method where the second entity is an UE, WTRU, network element, smart device, or IoT device hosting a software application or storing executable instructions which cause a specific task to be performed. Implementations of the described techniques may include hardware, a method or process, or a computer tangible medium.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of task assignment for deploying and operating a distributed 6G AI/ML application;

FIG. 3 illustrates an example task-level trust evaluation workflow;

FIG. 4 illustrates a general workflow of a Blockchain System;

FIG. 5 illustrates an example process of decentralized resource provisioning for 6G task assignment;

FIG. 6 illustrates an example of establishing a three smart contracts between three entities;

FIG. 7 illustrates an example process of decentralized resource provisioning for 6G assignment via task replacement;

FIG. 8 illustrates an example process of decentralized resource provisioning for 6G assignment via task replacement and task migration according to an embodiment;

FIG. 9 illustrates an example process of decentralized resource provisioning for 6G assignment via task replacement and task migration according to an embodiment;

FIG. 10 illustrates an example process of decentralized resource provisioning for 6G assignment via task replacement and task migration according to an embodiment;

FIG. 11 illustrates a process of decentralized resource provisioning for 6G assignment via task replacement in a 3GPP architecture with 3GPP procedures;

FIG. 12 is a flowchart of an example process of decentralized resource provisioning for 6G task assignment and task replacement performed by a first entity; and

FIG. 13 is a flowchart of an example process of decentralized resource provisioning for 6G task assignment and task replacement performed by a second entity.

### DETAILED DESCRIPTION

### Abbreviations

3D Three Dimensional
3GPP 3^{rd} Generation Partnership Project
5G 5^{th} Generation
5GC 5G Core Network
5GS 5G System
6G 6^{th} Generation
6GC 6G Core Network
6GS 6G System
AF Application Function
A Artificial Intelligence
AMF Access and Mobility Management Function
API Application Programming Interface
AR Augmented Reality
CM Connection Management
DLS Distributed Ledger Service
DLAF Distributed Ledger Anchor Function
DLE Distributed Ledger Enabler
DLRF Distributed Ledger Repository Function
DLS Distributed Ledger Service
DN Data Network
E2E End-to-End
ETSI European Telecommunications Standards Institute
FQDN Fully Qualified Domain Name
GMLC Gateway Mobile Location Centre
GOT Generic Operation Type
IMEI International Mobile Equipment Identity
IP Internet Protocol
ISG Industry Specification Group
ML Machine Learning
MNO Mobile Network Operator
NEF Network Exposure Function
NF Network Function
NG-RAN Next-Generation RAN
NRF Network Repository Function
P2P Peer-to-Peer
PCF Policy Control Function
PDU Protocol Data Unit
ProSe Proximity-based Service
RAN Radio Access Network
RM Registration Management
SA Service Architecture
SC Smart Contract
SEAL Service Enabler Architecture Layer
SMF Session Management Function
SUCI Subscription Concealed Identifier
TES Trust Evaluation Service
TI Task Initiator
TIDC Trust InDiCator
TP Task Participant
UDM Unified Data Management
UDR Unified Data Repository
UE User Equipment
UPF User Plane Function
URL Uniform Resource Locator
VAL Vertical Application Layer
XR Extended Reality

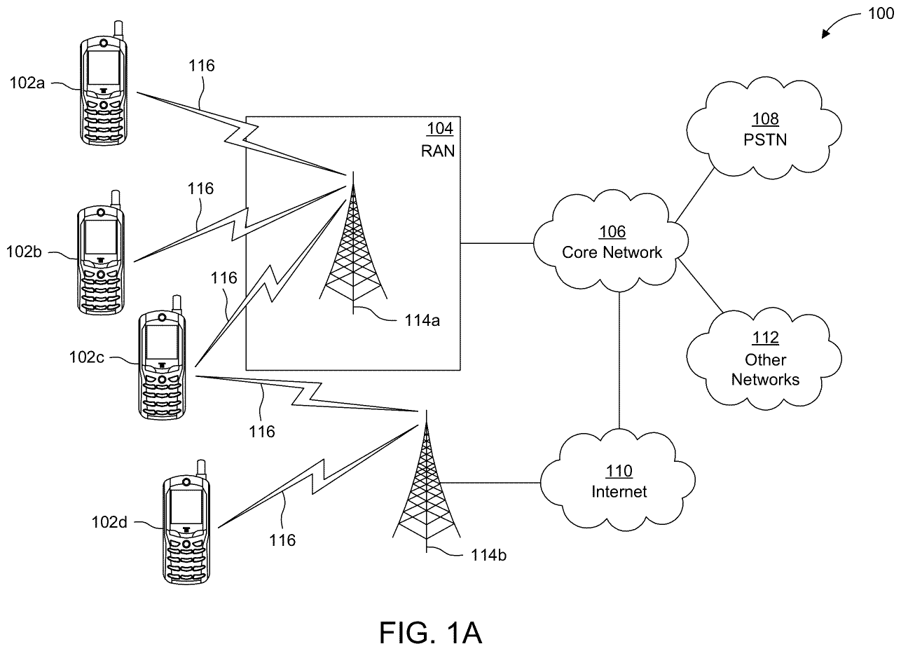

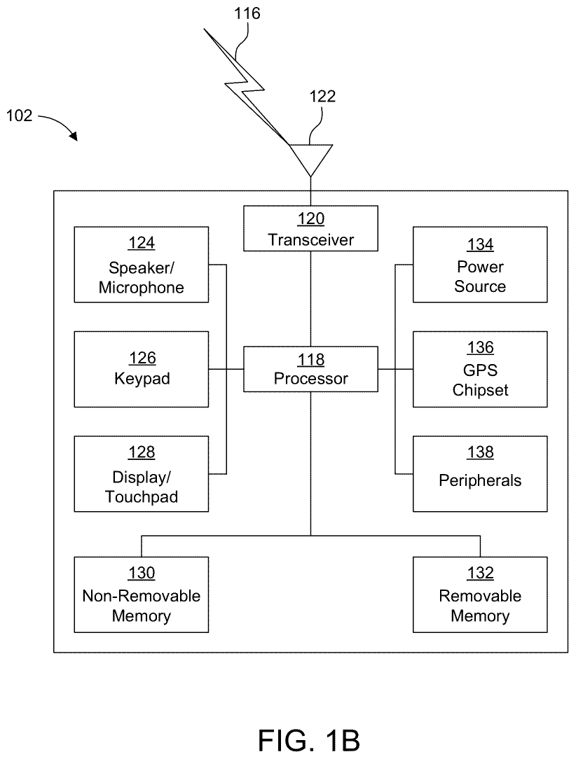

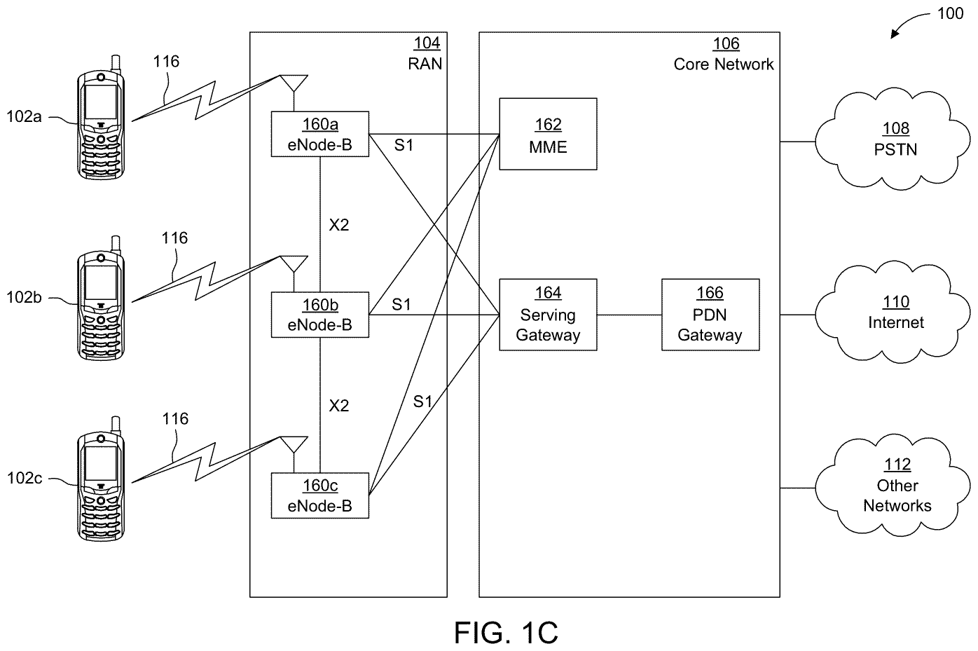

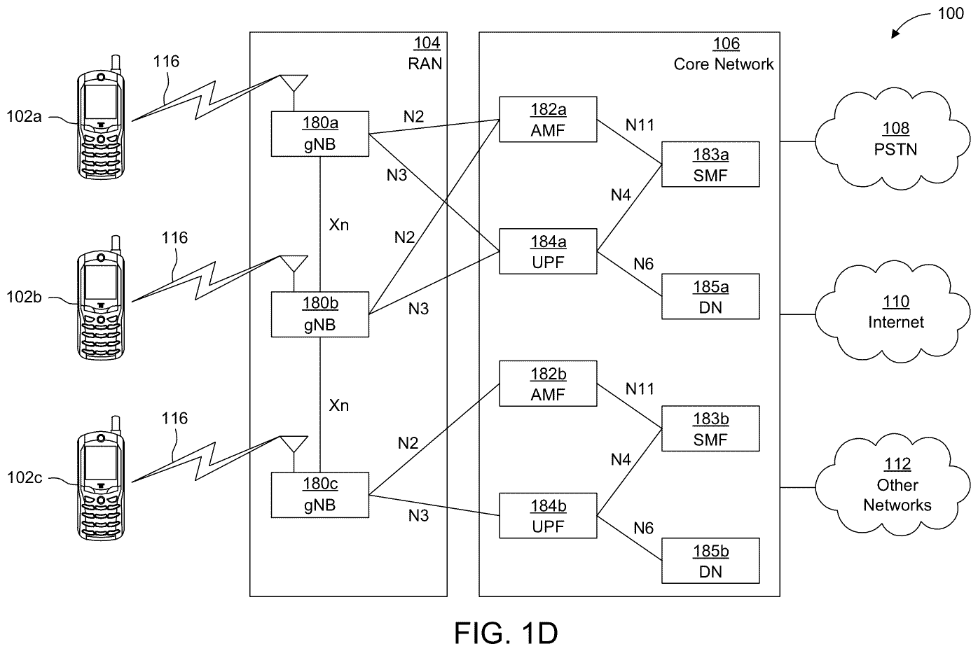

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For ease of discussion, a task may be viewed as one task involved with conducting one particular type of operation, for example a computing-related operation, a communication-related operation, or a data source-related operation. A task may be assigned to a task participant (TP) for execution. In other words, if a TI needs a TP to conduct two types of GOT operations, the TI needs to assign two different tasks to the TP.

A task initiator (TI) may be viewed as an entity that initiates one or more tasks. To deploy and operate a distributed 6G vertical application or a 6G system feature, a TI may need to assign a number of tasks to different UEs/WTRUs/entities/devices, so that those WTRUs may work together to realize the distributed 6G application or the 6G system feature desired by the TI.

A task participant (TP) may be a UE/WTRU/network entity/device that is deployed and/or operates a distributed application or a system feature and is assigned one or more tasks by a TI.

An aspect described is how task replacement can be used in trust-aware decentralized resource provisioning. A second entity corresponding to a TI may send a first request, for example a task assignment request, to a first entity corresponding to a TP. The first request may contain an identifier of the second entity, for example a WTRU ID plus a TI role indicator, a first smart contract (SC-1) that contains the identifier of a first task (e.g. task ID), a task execution guideline of the first task, a specific set of trust evaluation criteria regarding how the first entity's trust should be evaluated, and a desired trust level that the second entity expects the first entity to achieve when performing the first task, and related rules/policies for the task execution.

The second entity (TI-1) may receive a first response from the first entity (TP-1) that the first request is rejected and a first task replacement proposal. The first task replacement proposal may contain an identifier and contact address of a third entity (e.g. TI-2), and an identifier of a second task to be replaced by the first task. In a case where the second entity (TI-1) agrees with the first task replacement proposal, it may draft a second smart contract (e.g. SC-2) to be established between the second entity and the third entity (TI-2);

The second smart contract (SC-2) may contain all the details about the first task replacement proposal, a promised compensation that the first entity is willing to pay to the third entity, the account of the first entity in a first distributed ledger system (e.g. a distributed ledger address of TI-1) and any other policies/rules about the task replacement.

The second entity (TI-1) may send a second request (e.g., a task replacement initiation request) to the third entity (TI-2) where the second request may contain the second smart contract (SC-2). The second entity (TI-1) may receive a second response from the third entity (e.g. TI-2). The second response may contain the acceptance of the second smart contract and a confirmation that the third entity will record the second smart contact in the first distributed ledger system. The second entity may receive a third request from the first entity (TP-1), and the third request may confirm that the task replacement associated with the second smart contract will be conducted and the first smart contract will be recorded in the first distributed ledger system via DLS by the first entity.

The second entity may send a third response to the first entity (e.g. TP-1) where the third response may indicate its awareness of the task replacement to be conducted. The second entity may receive a first notification from the first entity (e.g. TP-1) where the first notification may indicate that the required task replacement is completed.

An artificial intelligence (AI) system can learn and exploit the physical world, for example: existing data sets, entity behavior, sensory information, etc., to train AI models based on various learning schemes such as deep learning, federated learning, reinforcement learning, and/or a combination of the learning schemes. The trained model can automatically discover useful knowledge, make decisions or have application-specific skills, for example driving a car. An example general AI pipeline of supervised learning may consists of multiple stages including: 1) the data preparation stage that includes data collection and optional feature engineering/extraction used for training; 2) the training stage for learning an AI model; 3) the validation stage for testing and validating the learned AI model; 4) model deployment stage for deploying the validated AI model to a place where the model is to be used; and 5) model application and operation stage for using the deployed AI model for various application purposes.

For example, 3GPP TS 22.261 specifies AI model transfer requirements for three types of AI operations: AI operation splitting between AI endpoints; AI model/data distribution and sharing over 5G system (5GS); and distributed/federated learning (FL) over 5GS. 3GPP TR23.700-80 aims to define intelligent transmission support for AI-based services in 5GS. It focuses on 5GS architectural and functional extensions so that service providers can leverage 5GS as the intelligent transmission platform to support AI-based services.

TR 23.700-80, for example, has several main objectives: study the possible architectural and functional extensions to support the application-layer AI operations defined in TS 22.261; study possible QoS, policy enhancements to support Application AI operational traffic while supporting regular 5GS user traffic; and study whether and how 5GS provides assistance to an application function (AF) and a WTRU/UE for the AF and WTRU/UE to manage the FL operations and model distribution/redistribution (e.g., FL members selection) to facilitate collaborative AI between the application clients running on the WTRUs/UEs (i.e., FL Clients) and the Application Servers (i.e., the FL Server). The result of 23.700-80 is a set of general architecture principles, which may further affect the related procedures/architectures defined in TS 23.501, TS 23.502, and TS 23.503.

As another example, 3GPP TR 22.876 studied the use cases and potential service and performance requirements for distributed AI training/inference involving direct device connection, which has the following two objectives: Distributed AI training/inference based on device-to-device connection; and Charging and security aspects. The result of TR 22.876 is a set of new functional and/or performance requirements, which will be addressed during the normative stage and may affect TS 22.261.

Trust may refer to a measurable belief that represents an accumulated value (e.g. about the quality/behavior/performance/characteristic of a network node, a WTRU/UE, a service or any logical/physical entity) from history and the expected value for the future. Trust may be an objective trust or a subjective trust. An objective trust leverages the security mechanism, such as authentication, to validate an entity's identity. Trust, however, may cover parameters beyond security. For example, an entity passing the authentication only means the entity has successfully proved its identity, it still may not be fully trusted since the trust concerning the entity's behavior/characteristics could still be dynamically changing and the criteria for evaluating trust may also be subjective, for example based on user/personal experience/preference. Trust is an essential input for decision making and it is usually measured or calculated based on the past history experience/records, and it represents the expected value of quality, behavior, characteristics, and/or performance in the future.

A Trust Index may be obtained via a Trust Evaluation (TE) process. A trust index can be used to describe the trust level of an entity. The trust index is an overall metric, which is often calculated based on the aggregation of one or more Trust Indicators (depending on the user's subjective trust evaluation criteria) using certain trust evaluation algorithms. The trust indicators may cover various aspects, such as security, privacy, resilience, performance, robustness, scalability, availability, accuracy, reliability, consistency, etc. During a trust evaluation process, various data about an entity can be collected and those data could be used as inputs to calculate various trust indicators, which in turn are aggregated into an overall metric, i.e. the current trust index of the entity. Trust has various characteristics. For example, trust is dynamic, meaning that a given trust index may be applicable for a limited time period and may change as time goes on. Trust is also context-dependent, which means that the trust can have a significant change if the context gets changed. Trust is not transitive in nature, but trust may be transitive in particular contexts. Similarly, trust is an asymmetric relationship, meaning that a fact of entity A trusting entity B cannot deduce that entity B also trusts entity A. In addition, trust could also be subjective, which means for the same entity, different users may have different criteria/opinions/preferences regarding how to evaluate the trust of this entity and what kinds of trust-related aspects/indicators shall be considered, etc.

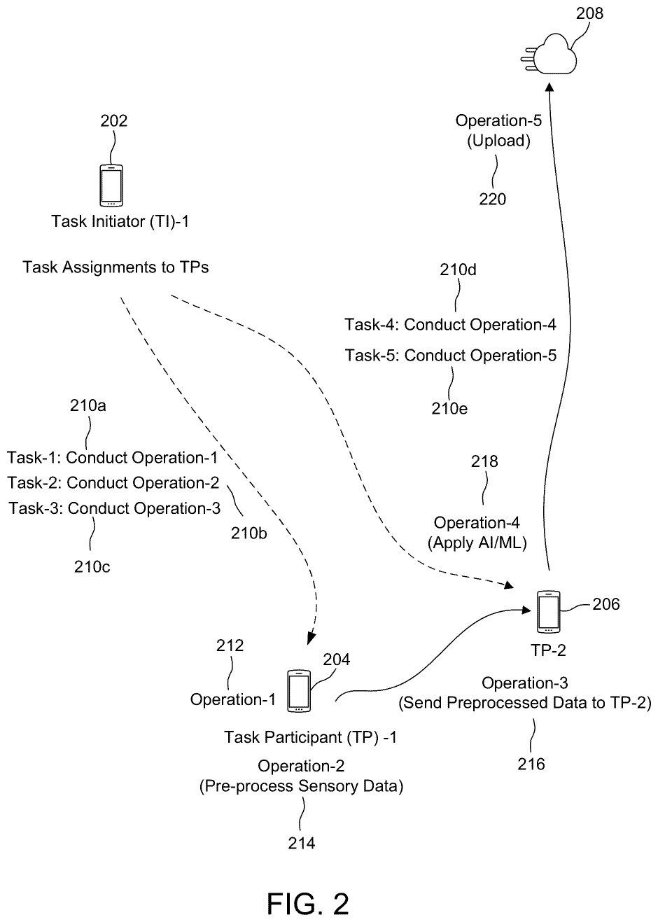

FIG. 2 illustrates an example task assignment for a deploying and operating a distributed 6G AI/ML application. In the example of FIG. 2, a number of operations are involved. Data is generated and collected, the collected data is input into an AI/ML model, the AI/ML model processes the data, and the prediction results may need to be submitted to a remote entity for further processing.

To realize this example application, a TI may intend to find multiple TPs to collaboratively conduct the operations. A TI may assign different tasks to multiple WTRUs/UEs/devices functioning TPs and each TP is responsible for conducting one or more task(s).

For ease of description, a task may describe a specific type of operation that may need to be performed, and in the following description, one task may be assigned to one TP, but one TP may be assigned more than one task. A task requires a TP to conduct a type of operation. For purposes of this description, operations may generally be categorized into one of three Generic Operation Types (GOTs): GOT-1: Communication-related; GOT-2: Computing-related; and GOT-3: Data source-related. GOT-1 operations may involve data transmission and communication, and the data being transmitted could be any type of data. GOT-2 operations may involve any type of data computing or processing, and GOT-3 operations involve may data generation or capture, e.g. using various sensors/cameras, etc.

Each GOT may further have GOT sub types. A GOT sub type indicates the details regarding what exact operations are to be conducted for a task. For example, a “GOT sub-type” parameter may further indicate that the specific computing operations are image analysis/processing.

An entity that generates or initiates a task is defined as a Task Initiator (TI). A TI could be a human user, a WTRU/UE/device/gateway, a software application (installed on a WTRU/UE, a network entity, a mobile base station, or a network server), a network function in the 3GPP core network, an Application Function, or any non-3GPP WTRU/UE/device behind a 3GPP WTRU/UE, etc.

A TI may assign a task to an entity (e.g. a WTRU, a device, a gateway, a mobile vehicle, a road-side unit, etc.) so that this entity may conduct the operation required by the task. The entity assigned a task by a TI may be considered a Task Participant (TP).

Five tasks are illustrated in FIGS. 2 (210a-210e). A task may be modeled or described as the following tuple: Task={task identifier, involved TI, involved TP, GOT type, GOT sub-type, task description/instruction} and the parameters may indicate the following information: the “task identifier” is the identifier of the task, which may be assigned by a TI; the “involved TI” parameter indicates which entity initiates this task, for example, the identifier of the TI could be included in this parameter; the “involved TP” parameter indicates which entity needs to execute this task, for example, the identifier of the involved TP may be included in this parameter; the “GOT type” parameter indicates what specific type of operations the involved TP needs to conduct; the “GOT sub-type” parameter indicates the next level of details regarding what exact operations are to be conducted; and the “task description/instruction” parameter describes how the task should be conducted.

This description assumes that a given task is only associated with one particular GOT. However, if a TI wants a TP to conduct two different GOT operations, it may create two individual tasks and assign them to the TP for execution. In an example, for GOT-1 operations, the GOT sub-type parameter may indicate the specific communication operation is a WTRU/UE-to-Network Relay operation supported by 3GPP ProSe. If a task requires GOT-1 operations, the task description may advise what kinds of communication-related operations may be conducted, e.g. whether to pull certain data from another entity, or whether to send certain data to another entity, what kinds of communication medium should be used for data communication (e.g., via Wi-Fi or cellular link), when to conduct those operations (e.g., schedule), or any other instructions. In another example, if a task requires GOT-2 operations, the task description may describe what kinds of requests/data may be received and how to process the received data, for example a TP may need to use a specific software module/libraries/algorithm to process the received data/requests, etc.

As illustrated in FIG. 2, TI 202 may create five tasks (210a-201e) and each task is a request/instruction for a TP to conduct a certain type of operation. One example may be that TI 202 assigns tasks 210a-210c to TP-1 204 and assign tasks 210d and 210e to TP-2 206. As a result, TP 204 may first use its onboard sensors to generate the needed data (210a corresponding to Operation-1, which is a GOT-3 operation). Then, TP-1 204 may preprocess the data (210b corresponding to Operation-2, which is a GOT-2 operation) so that it may be ready for use as input into an AI/ML model. After that, TP-1 204 may deliver the preprocessed data to TP-2 (206) (210c corresponding to Operation-3, which is a GOT-1 operation). Once TP-2 206 obtains the data, it can input the data into an AI/ML model, which will process the data and produce a prediction result (210d corresponding to Operation-4, which is a GOT-2 operation). Finally, TP-2 206 may submit the prediction result to a remote entity 208 (210d corresponding to Operation-5, which is a GOT-1 operation). In this example, it can be seen that although Operation-2 and Operation-4 have the same GOT type, i.e. GOT-2, they have different GOT sub types; 210a corresponding to Operation-1 is related to sensory data preprocessing while 210b corresponding to Operation-2 is related to AI/ML model prediction.

An entity may have different levels of trust for executing different types of tasks/operations. For example, an entity may have a high-trust for performing communication-related operations, but may have a low-trust for performing computing-related operations, etc. Consequently, this description adopts a more granular approach, i.e. task-level trust evaluation, meaning that a given trust index of a TP describes the trust of TP for performing a particular task or a particular type of operation (i.e., a particular type of operation required by the task). For simplicity, in later sections, “performing or executing the operations required by Task-1” may, for example, simply be described as “performing Task-1.” When a TP is assigned multiple tasks, the TP may have multiple and different trust indexes for each of the assigned tasks, respectively. In other words, when evaluating the trust of a TP, it is necessary to specify what task or what specific GOT operation is involved (either GOT-1, GOT-2, or GOT-3).

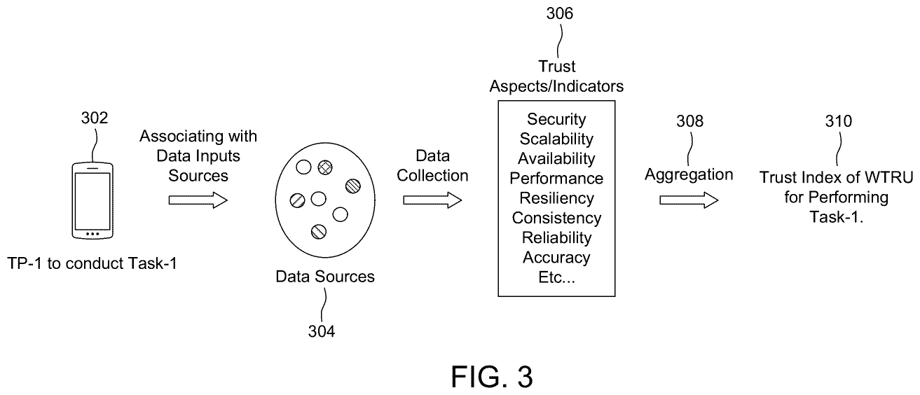

FIG. 3 illustrates an example task-level trust evaluation workflow. Initially, various data sources 306 that may produce data reflecting how TP 302 performs a task may need to be identified. For example, the available data sources 306 may either be TP 304 itself (e.g. a WTRU/UE) or other entities, such as a serving base station of TP 302, network functions (NFs) in the core network, etc. The trust evaluation desired by a TI (not shown) initiating Task-1 may involve different trust aspects, denoted as Trust Indicators 308. Trust indicators 308 may be calculated based on the data inputs 304 collected from available data sources 306. The Trust Index 312 of TP 302 for performing Task-1 can be further deduced based on the aggregation of different trust indicators 310.

Since trust evaluation may be subjective, different TIs may have different opinions/preferences regarding how the trust of a TP shall be evaluated. A TI may specify a specific set of Trust Evaluation Criteria, which may contain a detailed set of criteria regarding how trust evaluation shall be performed or evaluated. Each TI may create its own set of trust evaluation criteria based on the personalized need, or the system could define some standard or popular sets of trust evaluation criteria for TIs to select. A given set of trust evaluation criteria may specify the types of trust indicators considered and types of algorithms adopted for calculating the trust indicators or trust index.

For example, some TIs may prefer to consider reliability as a key trust indicator (having a large weight for calculating the overall trust index), while other TIs may not consider reliability during their trust evaluations or may consider reliability at different level of importance.

During the calculation of trust indicators or a trust index, the values of certain parameters may be fully customized, and different TIs may have different preferences regarding how to set values for those parameters. For example, one TI may think that if a TP can be available for performing the desired operations (required by Task-1) for more than 70% (defined as a customized threshold value) of the entire time, such a TP may be regarded as having a good availability. However, another TI may view a TP having a good availability if this TP can be available for performing Task-1 during 85% or 90% of the entire time, etc. As another example, when aggregating different trust indicators to calculate the final trust index of a TP, one TI may decide that the trust indictor “availability” is given a 15% weight while another TI may decide that availability may be given a 5% weight.

Distributed ledger technology (DLT) is a digital system that has advanced features such as decentralization, immutability, transparency, and security. A distributed ledger can record digital transactions or any other important information across multiple nodes in a DLT network simultaneously by leveraging a number of different technologies such as cryptography, hashing, Merkle tree, Peer-to-Peer (P2P) networking, and consensus protocols, etc. Blockchain technology is a special type of distributed ledger.

A general introduction of a blockchain system is provided herein. In a blockchain system, Blockchain Nodes (BCN) are connected via P2P links and form a mesh P2P network, over which transactions and blocks are broadcasted among all blockchain nodes. A blockchain node may connect to multiple other blockchain nodes as its neighbors or neighboring blockchain nodes. Applications using and/or supported by a blockchain system are referred to as blockchain applications. A blockchain system is underpinned by underlying blockchain networks which are composed of many participating blockchain nodes. Each blockchain node hosts one or more blockchains (a form of distributed ledgers) and participates in the blockchain system. For example, blockchain nodes broadcast blockchain transactions and blocks among each other using peer-to-peer networking; blockchain nodes also perform consensus protocols with each other to reach distributed trust and consensus without relying on a centralized party. A blockchain transaction could be a digital representation of a real-world transaction, a digital record of physical assets, a digital record of a physical event, a digital record of any action in an information system, a digital payment, and/or a digital smart contract; a block groups multiple blockchain transactions together.

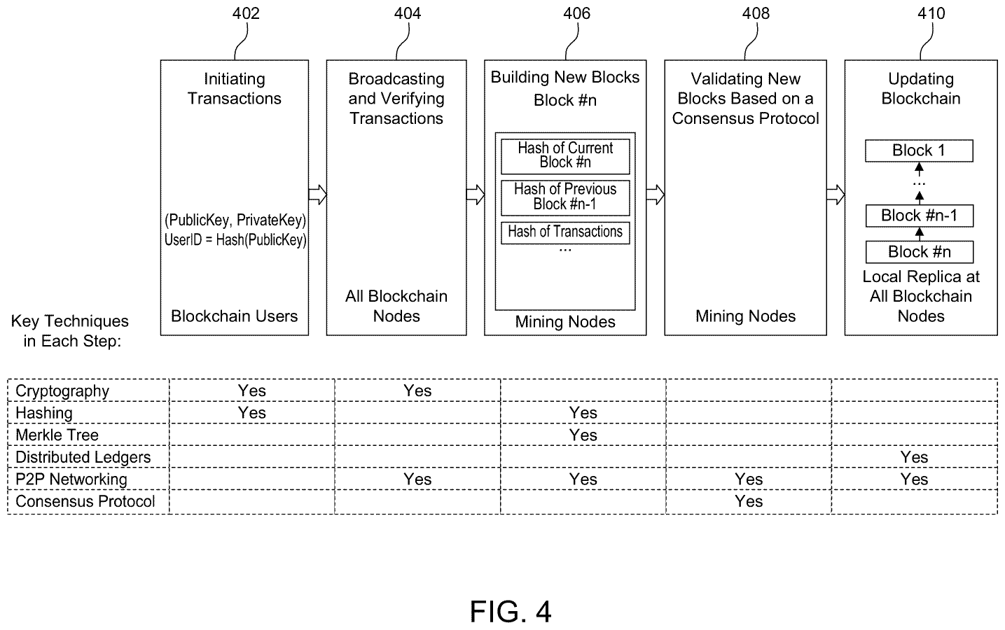

FIG. 4 illustrates a general workflow of a blockchain system, which consists of several states in a process. The process may start with initiating one or more transactions at 402. Each participating user generates new transactions independently. Each user has a user or account identifier, which is in general a hash of the user's public key. Each new transaction will be signed using the user's private key. After a new transaction is generated, the user sends it to the blockchain network. At 404 the transaction(s) are broadcast and verified. A new transaction will be first received by some blockchain nodes, which will verify its integrity using the user's public key, which is included in the transaction. After the verification and if the new transaction is valid, it will be relayed and broadcasted within the blockchain network. Eventually, all blockchain nodes will receive and have a copy of any newly generated and valid transactions.

At 406, some blockchain nodes (referred to as Mining Nodes or Full Nodes) start to group newly generated and pending transactions together to generate a new block. The new block will consist of a block header and a block body. The block header generally includes a hash of the current block, a hash of the previously-confirmed block (e.g. the last block on an existing blockchain), and a hash of all included transactions (e.g. Merkle tree). Depending on the consensus protocol, the block header may contain additional information. The block body contains the content of all included transactions. Each mining node independently attempts to create a new block.

At 408, new blocks are validated based on a Consensus Protocol. At 406, mining nodes independently attempt to create a new block. They run the same consensus protocol (e.g., Proof-of-Work in the Bitcoin system) and reach an agreement on who (i.e., a winner) is allowed to insert a block into the existing blockchain. The winner of the consensus protocol will send its newly generated block to the blockchain network. This new block will be broadcasted and let all mining nodes receive it and verify it. At 410, the blockchain is updated. After the newly generated block is verified, it is successfully appended to the existing blockchain, since it contains a hash of the previous block (i.e., the last block of the existing blockchain).

In 6G, WTRUs/UEs/devices may not only be consumers but also providers of services/resources (communication, computing, sensing, storage, etc.). A WTRU/UE or device can act as a TP for operating and running various communication/computing/sensing/storage tasks assigned by TIs. Thus, it is expected that future 6G applications or 6G native system features may be realized in a fully distributed way. For example, multiple WTRUs/UEs (as TPs) may be assigned different tasks by TI(s) so that those WTRUs/UEs work together to realize a 6G application or a 6G system feature. However, in reality, WTRUs (as TPs or TIs) may not be in the same trust domain, they may not have stable behavior/performance, or they may not act as commercial resource/service providers with a “pre-assumed” level of trust (in comparison, a company or a commercial service provider can be trusted based on their reputation). As an example, TPs could be personal smartphones, AR/VR devices, personal or shared electronic vehicles in a city, etc. Also, there is no guarantee that TPs are always willing to work diligently to perform tasks assigned by TIs. Overall, the trust of TPs may significantly affect the successful operation of distributed 6G applications or 6G system features.

This differs from the classical cloud or data center environment in which an orchestrator may have the direct management and control privileges over many worker nodes (as TPs). For example, a centralized orchestrator in a data center may conduct system-wide resource allocation, task assignment and scheduling across different worker nodes, which may be configured to follow the instructions/commands sent from the orchestrator. However, in a fully decentralized volatile environment, it is very challenging to have a centralized orchestrator to manage WTRUs/UEs/devices (as TPs), which may be distributed over a large geographical area, may not belong to the same organization or be owned/managed by the same orchestrator, or may join/leave or may be online/offline at random or unpredictable times, etc.

The description that follows considers a volatile environment, in which TIs may need to assign different types of tasks to distributed TPs for execution. In order to accept and execute a task with desired trust, a couple of requirements are identified. One requirement is that a TP needs to be “trust-aware” when conducting resource provisioning for a task(s). Given a task to be assigned by a TI to a TP, the TI may expect the task can be performed with a desired trust level. In particular, the TI may have its own criteria regarding how the trust of the TP should be evaluated. Due to lack of knowledge regarding resources (CPU/Memory/etc.) available to a TP, the TI may not be fully clear for specifying the amount of resources that may be needed for task execution in order to achieve the desired trust level. Instead, the TI may only be able to specify its needs on an abstract or an application-level e.g. in terms of a desired level of trust that the TI expects the TP to achieve. Accordingly, the TP needs to be trust-aware by interpreting a TI's needs on the trust and deciding/provisioning an appropriate level of resources for a specific task assignment (i.e. in a trust-aware manner).

Another requirement considers TI-TI interaction/coordination needs to be considered when conducting TP resource provisioning. Most existing work on resource provisioning focuses on interactions between TIs and TPs or among TPs themselves. However, interaction/coordination between TIs has not been adequately investigated regarding, for example, how TI-TI interaction and coordination can benefit or improve decentralized TP resource provisioning, etc.

One issue that is addressed is how a TP can be trust-aware for decentralized resource provisioning. When a task is assigned by a TI to a TP, the TI may only be able to specify high-level needs, such as the desired trust level to be achieved. That is, the TI may not know the amount of resources that are needed in order for the TP to achieve the desired trust. Thus, another issue is how a TP may analyze and interpret a TI's high-level trust needs and transform them into resource requirements by determining and allocating an appropriate amount of resources to the task. An associated challenge for TP is that the TP needs to dynamically adjust resource allocation to a task since the trust index of TP could be changing due to various reasons, for example, the desired trust level or the preferred trust evaluation criteria may be updated by the TI during the task execution or the workload complexity of the task may be changing, etc.

Another issue addressed is how TI-TI interaction may be helpful for TP resource provisioning across different tasks that may be initiated by different TIs. When TPs are distributed over a large geographical area and serve more than one TIs in a spontaneous and ad hoc manner, a solution is needed to enable decentralized resource provisioning and task assignment so that TPs may best utilize their resources for performing various 6G tasks assigned by one or more TIs. In particular, TPs are often constrained devices with limited resources and different TIs may assign multiple tasks to the same TP which may lead to resource contention among tasks and their corresponding TIs. In addition to interaction/coordination between a TP and a TI or among TPs, this description particularly describes how TI-TI interaction may be helpful for decentralized TP resource provisioning.

Addressing the above identified issues, procedures for a Trust-aware Decentralized Resource Provisioning for 6G task assignment are described.

Considering a solution to Trust-aware Decentralized Resource Provisioning for 6G Task Assignment, a TI may want to assign a task to a TP for execution. There is no centralized entity for coordinating or managing the resource provisioning. Instead, the TP manages its own resource provisioning in a fully decentralized manner by leveraging distributed ledger and smart contract technology. A TI may send a task assignment request to the TP that includes detailed task execution instructions, a set of preferred trust evaluation criteria, and a high-level or application-level description of trust-related need regarding a preferred trust level that the TP is expected to achieve. In an example, the description considers a scenario where the TI does not need to (or is not able to) specify the amount resources that are required for executing the task. Once the TP receives the request, the TP may analyze the task execution instruction, the trust evaluation criteria to be adopted, and the desired or expected trust level to be achieved. Then, it is the TP's responsibility to transform the high-level trust-related need(s) into the specific TP resource requirements. In other words, the TP will need to determine an appropriate amount of resources that are needed for executing the task and achieve the sufficient trust requested by the TI. A smart contract may be established between the TI and the TP, and the smart contract may be recorded in a distributed ledger system, which enables the decentralized trustworthiness between the TI and the TP. Once a TP starts to execute the task, a Trust Evaluation Service (TES) may be leveraged for evaluating the trust of the TP when it is executing the task. The TES may be trusted by both the TI and the TP. The TES may periodically calculate the latest trust of the TP and report it to the smart contract so that a payment/reward/penalty may be automatically calculated and transferred between the TI and the TP. A TES may be referred to by other names, such as Trust Management Function, Trust Management Service, Trust Index Calculator, Trust Inquiry Service, Trust Server, Trust Evaluation Server/Function, etc.

One solution described is Trust-aware Decentralized Resource Provisioning for 6G Task Assignment via Task Replacement. This solution addresses a new type of TI-TI interactions for enabling task replacement, which can be useful when the TP does not have a sufficient amount of resources required for the new task (e.g. Task-1) and task replacement may be needed. For example, when a TI assigns a new task to a TP, the TP may be short on resources needed for performing the new task. For example, a first task (Task-1) may be requested to be deployed to a TP by a first TI (TI-1). If the TP does not have sufficient resources to complete Task-1 with sufficient trust, the TP may try to determine if any on-going task, for example, Task-2 that was assigned to the TP by a second TI (TI-2) can be replaced by the new task (Task-1). If so, the TP may suggest such a task replacement proposal to TI-1. TI-1 may interact with TI-2 in order to establish a smart contract between them that prescribes the details of the task replacement, such as the compensation that TI-1 would be willing to pay TI-2 if TI-2 agrees to stop or suspend the operation of Task-2. The smart contract may be recorded in a distributed ledger system in order to take effect. With the smart contract in place, the TP may conduct task replacement so that the resources previously-allocated to Task-2 can now be used for performing Task-1. After Task-1 replaces Task-2, the TP may report to both TIs (TI-1 and TI-2) information about the task replacement completeness may be provided by sending a transaction to trigger enforcement of the smart contract established between two TIs.

Another solution described is Trust-aware Decentralized Resource Provisioning for 6G Task Assignment via Task Replacement and Task Migration. This solution addresses an additional new type of TI-TI interaction for enabling migration-destination TP identification. In the previous solutions, resource provisioning and task replacement was initiated by a TI, for example when the TI sends a task assignment request to the TP. In comparison, in this solution, the resource provisioning and task replacement is initiated by a TP. For example, during task execution, the TP may need to handle certain dynamics (e.g. dynamic changing workloads, emergency events, etc.) and to re-adjust the resource allocation to Task-1 in order to maintain a sufficient trust index desired/expected by TI. For example, more resources may need to be allocated to an existing task due to various reasons, such as: the workload of the task becoming larger such that that the resource requirements of the task increases; the corresponding TI of the task has increased its desired trust level and therefore more resources are needed to satisfy the trust level; and a corresponding TI updates its trust evaluation criteria, for example, the TI now requires to use more strict trust evaluation criteria, but at the same time, TI still expects the TP to achieve the same level of trust as before, e.g. high trust. Accordingly, the TP determines that more resources should be allocated to the task so that the TP may achieve a high trust based on the new trust evaluation criteria. This solution utilizes task replacement and additionally utilizes task migration. For example, when an existing task (e.g. Task-1) requires more resources, the TP may use task replacement in order to find the additional resources needed for the task. However, in certain cases, the TP may not be able to continue to serve the task in a case where the new resource requirement of the task may exceed the maximum resource capacity of the TP (denoted as migration-source TP). If that is the case, the impacted task may have to be migrated to another TP (denoted as migration-destination TP). Several variations regarding how to identify a migration-destination TP are described including: the migration source TP may suggest a migration-destination TP to the corresponding TI of the task to be migrated; the corresponding TI of the task to be migrated may identify a migration-destination TP by itself and then notify the migration-source TP to start migration; and the corresponding TI of the task to be migrated may ask other TIs for help in order to identify a migration-destination TP. This is a second new type of TI-TI interaction, which is to enable migration-destination TP identification.

It should be understood that, the roles described, such as TI, TP, DLS and TES, are logical roles. A given entity/device/WTRU/UE may realize one or more logical roles at the same time. For ease of description, different roles are performed by different entities when realizing the proposed solutions. This should not be viewed as limiting in any respect. The skilled artisan should appreciate that all of the proposed solutions described may be applicable to any possible case where an entity serves in two or more roles. For example, a given entity may act as both a TI and a TES.

A Distributed Ledger Service (DLS) is used as a general term, which could provide various existing/future distributed ledger technology solutions. For example, DLS could manage and interact with one or more specific underlying blockchain systems, which could provide blockchain or distributed ledger related storage capabilities. A DLS could also manage and interact with a database or a storage system.

As described, a smart contract is used for establishing work agreements or work contracts between different entities. A smart contract is often associated with a DLS. That is, a smart contract may need to be recorded in a distributed ledger. Alternatively, the smart contract may not rely on a DLS, but may be stored to and managed by a storage or repository system. It should be appreciated that the proposed solutions may also be applicable to cases where another type of approach/technology, other than smart contract, is used to record or form a work agreement or a work contract between different entities. For example, a 3rd party trustful authority, for example government agency, may be responsible for coordinating with different involved parties in order to establish a work agreement or a work contract between those entities. The 3rd party authority may record the work agreement in any storage repository and only the 3rd party authority may have the privilege to store, move, copy, edit, update or delete the agreement/contract. A smart contract or a work agreement may be established between two or more parties, for example between a TI and a TP, between two TIs, between one TI and multiple TPs, between multiple TPs, etc. A smart contract or a work agreement may be drafted, and once the content of the contract is agreed by all the involved parties, the smart contract or the work agreement may be finalized and ready for enforcement. For example, in case of smart contract, a finalized smart contract, which are essential software codes, can be deployed into distribute ledger system in order to enforce the smart contract. Any involved party may participate in drafting the smart contract and negotiating the contents of smart contract. As such, the term “drafting a smart contract or a work agreement” can refer to a node receiving relevant information and using the received information to build and record the context/instruction/policies/rules that constitute the contents of a smart contract. Alternatively, “drafting a smart contract or a work agreement” may also refer to a node sending a message containing relevant information to another node and the message requires the other node to use the received information to build and record the context/instruction/policies/rules that constitute the contents of a smart contract.

Trust is a focus and the primary purpose of establishing smart contracts among parties is to improve or enhance the trust of TP for performing a task for a TI. However, it is worth noting that proposed solutions may also be applicable to cases where the purpose of establishing smart contracts among different parties is to improve or enhance any other metrics that are not trust. In one example, trust may be defined in a narrow setting, e.g., trust is a metric and may only be related to security-related aspects, such as authentication/authorization, privacy, confidentiality, etc. Other aspects such as reliability, performance, agility, accuracy, scalability, resiliency, availability, consistency may be considered as peer metrics of trust. In that sense, proposed solutions may also be used to improve or enhance any of those metrics, such as reliability, performance, agility, accuracy, scalability, resiliency, availability, consistency, etc. of a TP performing a task. Solutions described may also be used to improve or enhance the user-related metrics, such as the quality of service or the quality of experience of the TP for performing a task, for example user experience. In another example, proposed solutions may be used to improve or enhance social metrics of the TP performing a task such as, sustainability, inclusiveness/pervasiveness, culture connection, digital connection, diversity, self-sovereignty, adequacy, cleanness, steadiness, accountability, traceability, efficiency, etc. For example, in the case where a TP's sustainability needs to be evaluated or monitored, the TES could perform a sustainability evaluation service and the TES may be leveraged to evaluate/measure/monitor the sustainability of a TP when it is performing a task.

A task may often require a TP to conduct a certain type of GOT operation. It should be understood that the proposed solutions are applicable to not only the case where GOT operations are application specific (e.g., to support a specific type of vertical 6G application, such as an AI/ML application, an AR/XR application, etc.), but are also applicable to cases where GOT operations are related to native 6G operations/processing, for example a GOT operation may represent a UE-to-Network Relay operation as, for example, supported by 3GPP ProSe.

The description uses the 3GPP 5G system as a typical example of a wireless system. However, the solutions described may also be used for the future generations of the 3GPP system (such as 6G and beyond), as well as any other types of wireless and fixed access systems (such as WiFi).

When explaining the details of the solutions provided, this description uses WTRUs/UEs, base stations, and network functions as an example of entities in the wireless system. However, the solutions may be applied to any terminals or entities, such as but not limited to laptops, Internet-of-Things devices, equipment, future cellphones, drones, roadside units, TV set-top boxes, gateways, access points, satellites, sensor nodes, robots, machines, routers, base stations, radio access network central units, radio access network distribution units, radio access network radio units, network functions in 5GS and/or 6GS, and the like. In addition, the description considers three GOT operations, computing, communication, and sensing. However, the solutions may also be applicable to any type of operation beyond computing, communication, sensing, such as storage, etc.

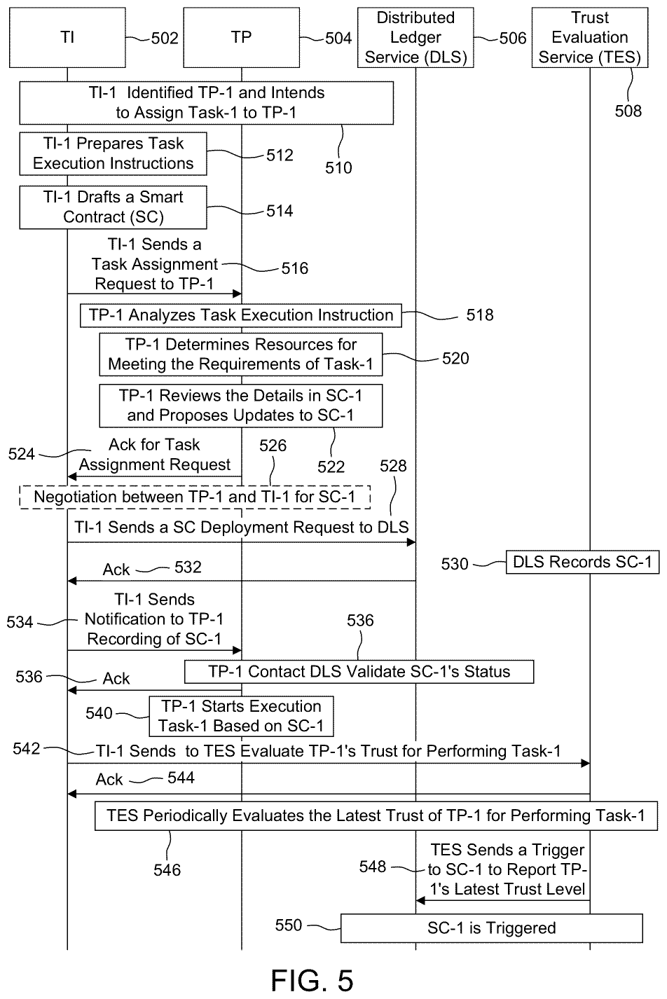

FIG. 5 illustrates an example process of Trust-aware Decentralized Resource Provisioning Task Assignment. This process may apply when a TI may want to assign a task to a TP for execution and the TP manages its own resource provisioning in a fully decentralized manner by leveraging distributed ledger and smart contract technology.

A TI may send a task assignment request to the TP by including task execution instructions, a set of preferred trust evaluation criteria, and a high-level or application-level description of trust-related need regarding a specified trust level that the TP is expected to achieve. Once the TP receives the task assignment request, the TP may analyze the request and it is the TP's responsibility to transform the high-level trust-related need(s) into the specific resource requirements. A smart contract may be established between the TI and the TP, recorded in a distributed ledger system, which enables the decentralized trustworthiness between the TI and the TP. Once TP starts to execute the task, TES may periodically calculate the latest trust of the TP and report it to the smart contract so that the payment/reward/penalty can be automatically calculated and transferred between the TI and the TP.

At 510, TI 502 identifies TP 504 and intends to assign a first task, Task-1, to TP 504. Distributed Ledger Service (DLS) is a service which manages different types of underlying distributed ledger systems. TIs/TPs could interact with DLS in order to leverage those distributed ledger systems. For example, TIs/TPs may write or read transactions from a particular distributed ledger system or could deploy/record a smart contract in a particular distributed ledger system. A Trust Evaluation Service (TES) is trusted by both TIs and TPs and it can conduct trust evaluations on TPs and produce trust indexes.

At 512, TI 502 prepares task execution instructions and decides a set of trust evaluation criteria for Task-1. TI 502 also decides a desired/expected trust level to be achieved. The task executions instructions may be sent to TP 504 in a task assignment request. The task assignment request may include a number of parameters. These parameters may be related to the task execution instructions and trust evaluation criteria.

The following information may be included in the task execution instructions. The task identifier, such as the identifier of Task-1. The type of GOT operations Task-1 requires TP 504 to perform. For example, Task-1 may require TP 504 to conduct GOT-2 operations (i.e. computing-related operations). The GOT sub type of the operations that Task-1 requires TP 504 to perform. For example, Task-1 may require TP 504 to conduct specific computing operations related to image analysis/processing.

If Task-1 requires TP 504 to conduct GOT-1 operations (communication-related), the work instructions may include the communication interface(s) that may be used. For example, Task-1 may require TP 504 to use a 3GPP D2D communication interface or Wi-Fi interface when executing Task-1. The work instructions may include a data delivery approach to be adopted, push-based or pull-based. As described, if Task-1 is to adopt a push-based approach for data delivery, Task-1 will be assigned to a data sender. In other words, if TP 504, acting as a data sender, is assigned with Task-1 and a push-based approach is adopted, TP 504 will be responsible for proactively sending data to another entity that is acting as a data receiver. If Task-1 is to adopt a pull-based approach for data delivery, Task-1 will be assigned to a data receiver. In other words, if TP 504 is assigned with Task-1 and a pull-based approach is used, TP 504, acting as a data receiver, will be responsible for first sending a data retrieval request to another entity acting as a data sender and then receiving the required data in the response.

If Task-1 requires TP 504 to conduct GOT-2 operations (computing-related), the work instructions may include detailed information about the software that needs to be installed by TP 504 for executing the operations required by Task-1, such as: the name of the software, the identifier of the software, the size of the software to be installed, and the downloading address of the software.

The input data that may trigger the computing processing of Task-1, may include: an external request received from the communication interface and forwarded to the CPU of TP 504 for processing. For example, a data delivery request may be sent from another entity, which requires TP 504 to complete certain GOT-2 operations on the received data; and an internal request sent from another application process hosted on TP 504. For example, an application may collect certain data from on-board sensors and then send the collected data to the CPU for processing.

The output data, of Task-1 may be stored in the local storage of TP 504. The data may be sent to the communication interface if the data needs to be delivered to another entity.

If Task-1 requires TP 504 to conduct GOT-3 operations (data source related), the work instructions may include: the type of data that is expected to be captured or created; the required sensors or other equipment for generating the needed data; and how the data may be captured or created, such as sampling rate, sample quality, the desired quality of the data (e.g. images), such as size, resolution, etc.

The requests that might trigger GOT-3 operations, which may include: an external request associated with Task-1 that was received from a communication interface, e.g. a request sent from another external entity, which requires TP 504 to capture certain sensory information; and an internal request that was triggered by an application process hosted on TP 504 based on certain business logic associated with Task-1; and where the captured sensory data shall be delivered. This may include, for example, the captured sensory data may be stored in the local storage/buffer of TP 504; the captured sensory data may need to be sent to the CPU of TP 504 for processing; and the captured sensory data may need to be sent to a communication interface so that the data can be delivered to another external entity.

A description of the task complexity/scale/workload of Task-1 may be included to indicate the workload or the estimated difficulty for executing Task-1. For example, TI 502 may indicate how long Task-1 shall be executed (e.g. one hour), and in each of time internal (e.g. every ten minutes) and how the number of requests is expected to be processed. The description of the task complexity/scale/workload of Task-1 may include: the total time duration of Task-1 which is to indicate the execution time length of Task-1, e.g. TP 504 needs to execute Task-1 for one hour, or until receiving a task termination command; and an estimated workload schedule. For example, assuming Task-1 is to be executed for one hour, TI 502 may indicate for each 20-minute time interval, how many requests are expected to be received by TP 504 for processing. As an example, the first 20-min: 20 requests to be received/processed in maximum, the average data size to be processed in each request is 3 MB (the maximum data size of the request will not exceed 10 MB), the second 20-min: 60 requests to be received/processed in maximum, the average data size to be processed in each request is 5 MB (the maximum data size of the request will not exceed 7 MB), the third 20-min: 10 requests to be received/processed, the average data size to be processed in each request is 1 MB, etc.

The task execution instructions may include an indication from TI 502 whether Task-1 can be stopped and replaced by another task while TP 504 is executing Task-1. This may be to support the possible task replacement at TP 504, when TP 504 is short on resources and needs to recycle the resources allocated to Task-1 and reallocate them to another task.

The task execution instructions may also include task execution triggers. This may be to indicate that once TP 504 accepts Task-1, when Task-1 should be executed. For example, TP 504 may conduct Task-1 based on a work schedule, or TP 504 may start the execution of Task-1 based on events, for example receiving certain requests associated with Task-1, and in order to process those requests, Task-1 needs to be executed, etc., or TP 504 may start execution of Task-1 when an essential resource becomes available.

Another part of the task assignment request may be related to trust evaluation criteria. TI 502 may create and specify a set of trust evaluation criteria based on its personalized need, which define how TP 502's trust for performing Task-1 should be evaluated. A set of trust evaluation criteria mainly specify the types of trust indicators that may be considered, the specific type/kind of algorithms that may be adopted for calculating considered trust indicators and the final trust index, and the parameter values configurations. A set of trust evaluation criteria may include the parameters described below.

A summary of trust indicators given attention by TI 502. These may be trust indicators that are important to TI 502. A specific trust indicator X may be denoted as TIDC_X. This is to indicate what specific trust indicators are of interest to TI-1. As an example, the following four trust indictors may be of interest to TI 502:

$$TIDC\_X1 = Availability ( non - security - related )$$

$$TIDC\_X2 = Security ( security - related )$$

$$TIDC\_X3 = Scalability ( non - security - related )$$

$$TIDC\_X4 = Reliability ( non - security - related )$$

For a given TIDC_X, if TIDC_X is a non-security-related trust indicator, its value may be calculated based on a set of collected data. The detailed information that follows may be specified: The focus of TIDC_X; needed data inputs of TDIC_X; applied calculation algorithms of TDIC; and parameter value settings for TIDC_X.

The focus of TIDC_X may be to indicate what specific aspect is given attention by TIDC_X. An example value could be “Availability.” A parameter corresponding with the needed data inputs of TIDC_X, may contain a list of data inputs needed to evaluate TIDC_X. For example, assuming TIDC_X is to evaluate the availability of a TP for performing GOT-2 operations, one data input could may be: among all GOT-2 requests allocated to TP 504 for processing, how many requests were accepted by TP 504 immediately, and how many were rejected or no response in the last ten minutes.

The applied calculation algorithms of TIDC_X may be to indicate what type/kinds of algorithm may be used to derive TIDC_X. For example, “XYZ algorithm” may be adopted. TI 502 may indicate a list of preferred algorithms in a priority order so that TP 504 may choose one to adopt. Also, TI 502 may indicate where to download the algorithms in case TP 504 does not have a specified algorithm. The parameter value settings for TIDC_X may include specific values for a given aspect of a TFIC_X. Continuing with the previous example, TIDC_X refers to availability, TI 502 may set the values for the following two thresholds, which are two standard parameters used in the XYZ algorithm listed in the above.

The threshold for high-availability=75: this may mean that for a given task, if 75% of requests associated with the task were accepted and processed by a TP immediately, then it can be regarded that this TP has a “high” availability for performing the task. The threshold for medium-availability=50: this may mean that if 50-75% of requests associated with the task were accepted and processed by a TP immediately, then it can be regarded that this TP has a “medium” availability for performing the task. Otherwise, If less than 50% of requests associated with the task were accepted by a TP immediately, then it can be regarded that this TP has a “low” availability for performing the task.

Another extension may also be to consider a requested priority when calculating the value of TIDC_X. The may be used when requests associated with the same task may have different priorities, for example, some requests may have higher priorities (e.g. time-critical or mission-critical requests or some of requests to be processed are sent from a critical or VIP entity). Accordingly, a request having a higher priority, assuming a priority indicator can be included in the request, may have a larger impact/weight when calculating TIDC_X than a medium/low-priority request.

For a given TIDC_X, if the TIDC_X is a security-related trust indicator (such as “authentication”), its value may be derived based on proof or validation of whether a TP has certain capabilities. For example, TIDC_X may define what types of capabilities may need to be validated. This may include required proofs or declarations for evaluating TIDC_X. This may be to indicate what type/kinds of proofs and declarations may be identified in order to demonstrate a TP reaches a certain level of score (e.g. high/middle/low) on TIDC_X. For example, for a given targeted TP, one or more proof or declarations needs to be validated, for example, Declararion-1 may indicate the TP has already been authenticated by its serving wireless network operator and Declaraition-2 may indicate the TP has also been authenticated by its affiliation organization, e.g. via Microsoft authentication service.

Capabilities that may need to be validated may include a definition of how to derive of the value of TIDC_X, e.g.: If only Declaration-1 can be validated, then TP's score/rank on authentication is considered as “medium.” If both Declaration-1 and Declaration-2 can be validated, then the TP's score/rank on authentication is considered as “high.”

The declarations required for evaluating TIDC_X may be from the TP itself. In order to validate or justify the truth of the declarations or proofs (announced by the TP), the following approaches may be adopted. The TP may provide certain proofs about whether it has a certain capability. For example, the TP may send some example messages to TES or TI in order to demonstrate this TP could conduct integrity-protection or confidentiality protection on the messages. The TP may also indicate one or more endorsers to make an endorsement to it. For example, the previous TIs that have worked with the TP could be potential endorsers. The TP may publish its security-related declarations to an immutable distributed ledger system. Therefore, the TP may declare that if any declaration stored in the distributed ledger system is not truth, a certain penalty may be applied.

Overall, a TP may declare various security-related capabilities such as privacy, confidentiality, authentication, integrity, etc. Those declarations may be used to evaluate one or more trust indicators. Some examples may include communication-related and computing related.

Communication-related may include: authentication-related, confidentiality, and integrity.

Authentication-related may be when a TP has already been authenticated by the wireless system and/or TES. Confidentiality may be when a TP may have security keys for securing the messaging, which are required during the execution of a task. Also, the TP has the capability to apply ciphering algorithms to conduct confidentiality protection on all the messaging, which is required during the execution of a task. Integrity may be when a TP has the capability to apply a certain protection algorithm to protect the integrity of messaging and/or to verify signatures generated under the same protection algorithm, which are required during the execution of a task.

Computing-related may be when a TP has already installed the desired antivirus software with the most recent updates and/or when the TP has installed a Trust Execution Environment (TEE)

The set of trust evaluation criteria may include the parameters for “Applied calculation algorithms of Trust Index (TIndex).” This may be to indicate what algorithm is adopted to calculate the trust index by aggregating a list of trust indicators. One example is that the weighted average algorithm is adopted. The final TIndex could be a rank value such as low/medium/high, or a score-like value ranging from 0 (lowest_trust)-99 (highest trust). A TI may indicate a list of preferred algorithms in a priority order so that TP may choose one to adopt. Also, the TI may indicate where to download the algorithms in case TP does not have one.

The set of trust evaluation criteria may include “Parameter value settings for TIndex.” This may be to indicate the various parameter setting when calculating the TIndex. As an example, assuming that the weighted average algorithm is used for integrating all the trust indicators for calculating TIndex, the weights of different trust indicators may be included in this parameter:

$$TIDC\_X1 ( Availability ) weight = 0.4$$

$$TIDC\_X2 ( Security ) weight = 0.4$$

$$TIDC\_X3 ( Scalability ) weight = 0.1$$

$$TIDC\_X4 = ( Reliability ) weight = 0.1$$

Another part of the task assignment request may include a trust level desired/specified by TI 502. Based on a set of trust evaluation criteria preferred by TI 502, as described above, TI 502 may further specify a desired trust level, which indicates TI 502 expect TP 504 to achieve what level of trust (e.g. a threshold) when performing Task-1. For example, assuming TIndex ranges from 0-99, TI-1 may expect TP-1 to achieve TIndex>=75 (as a desired trust level) when TP-1 is executing Task-1.

At 514, TI 502 drafts a Smart Contract (SC-1) to include detailed information about Task-1. TI 502 may also decide a preferred distributed ledger system, where the smart contract is to be recorded. SC-1 may include an identifier of a task, an identifier of the involved TI, a corresponding distributed ledger account/address of the involved TI, an identifier of involved TP, a corresponding distributed ledger account/address of the involved TP, a detailed task execution instructions of the involved task, a set of trust evaluation criteria to be adopted, a trust level to be achieved by the involved TP, clauses/terms/policies to be included in the smart contract, and indicate which entity may trigger the smart contract, for example TI 502, TP 504, or the TES. For example, once the TES produces a new trust index of TP 504 for performing Task-1, TES may report such trust index to SC-1, so that SC-1 may automatically conduct payment transfer between TI 502 and TP 504.

The identifier of the task is to indicate this smart contract is related to which task, e.g. Task-1. The identifier of involved TI is to indicate the task is initiated by which TI, e.g. TI 502. The corresponding distributed ledger account/address of the involved TI, for example, could be a specific distributed ledger account/address of TI 502 in the preferred distributed ledger system. The identifier of the involved TP is to indicate the task is to be assigned to the specific TP, e.g. TP 504. A corresponding distributed ledger account/address of the involved TP may be blank and may be filled by the TP in a later step. The detailed task execution instructions of the involved task, the set of trust evaluation criteria to be adopted, and the set of trust evaluation criteria to be adopted may be decided at 512.

The clauses/terms/policies to be included in the smart contract may indicate applicable rules or policies related to Task-1. This may include a service fee to be paid by TI 502 which may indicate the service fee TI 502 would pay TP 504 if Task-1 can be performed with desired trust level. This may also include a penalty fee to be paid by TP 504. To enable TP 504 to have an obligation and to give an incentive to execute Task-1 with the desired or expected trust level, TI 502 may also propose some penalty-related policies with TP 504. For example, a certain penalty may be incurred for TP 504 if it has accepted the task assignment request from TI 502 but at a later time, it decides not to execute Task-1 due to a shortage of resources. or if ultimately TP 504's trust level for performing Task-1 is too far away from the trust level desired by TI 502. The penalty can be a compensation to TI 502 since TP 504 wastes TI 502's time.

This information may include who may trigger the smart contract, such as TI 502, TP 504 or TES 508. For example, once TES 508 produces a new trust index of TP 504 for performing Task-1, TES 508 may report such trust index to SC-1, so that SC-1 may automatically conduct payment transfer between TI 502 and TP 504.

At 516, TI 502 sends a task assignment request to TP 504 and this request may include the following. The identifier of a task. This is to indicate this smart contract is related to a specific task, e.g. Task-1. The identifier of involved TI. This is to indicate the task is initiated by a specific TI, e.g. TI 502. The identifier of involved TP. This is to indicate the task is to be assigned to a specific TP, e.g. TP 504. Detailed task execution instructions of the involved task. This may be decided at 512. A set of trust evaluation criteria to be adopted. This may be decided at 512. A desired trust level that may be specified by the involved TI. This may be decided at 512. The drafted smart contract, e.g. SC-1 decided at 514. A preferred distributed ledger system. This may be to indicate where the smart contract is to be recorded.

Other approaches may also be used for task assignment. For example, TI 502 may send the task execution instruction of Task-1 via a management entity such as a task assignment function, a task deployment function, a task orchestrator function, etc. The management entity may further forward the task execution instruction to TP 504. Alternatively, TI 502 may be in the role of a task assignment function, a task deployment function, or a task orchestrator function, etc.

As an example, at 516, TI 502 may send a task assignment request to TP 504, which may assign multiple tasks to TP 504 at the same time (i.e. Task-1 may be just one of them). Each of tasks to be assigned to TP 504 may have the same set of parameters as listed above. As a representative example for illustration, the remaining process assumes that at 516, TI 502 only assigns one task (i.e. Task-1) to TP 504. This is simply for ease of description and should not be viewed as limiting in any aspect.

At 518, TP 502 may analyze different sets of information received at 516. TP 504 may examine the task execution instruction in order to understand how task should be executed. For example, the task execution instruction may not only indicate what actions or operations are involved in the task, but also the task complexity/scale/workload of Task-1, such as how many requests are to be processed by TP 504 during a specific time internal and the average data size of each request to be processed, etc. TP 504 may analyze trust evaluation criteria in order to understand how TI 502 would like to evaluate TP 504's trust for performing Task-1. TP 504 may also examine what type/kinds of trust level TI 502 expects TP 504 to achieve when performing Task-1.

Note that the above analysis may be performed in any order and can be stopped when any of part of the analysis cannot be met. For example, TP 504 may first evaluate what kind(s) of trust level TI 502 expects TP 504 to achieve, if the expected trust level is too high to be achieved, TP 504 may not need to evaluate how the task needs to be executed. If that is the case, TP 504 may directly send a rejection response at 524.

The above information may be regarded as abstract or application-level needs of Task-1, which should be supported by using certain resources of TP 504. Accordingly, based on this information, TP 504 may transform these high-level/trust-related needs into its resource requirements and determine how many resources (e.g., the amount of computing/communication/sensing/etc. resources) should be provisioned to Task-1 so that TP 504 achieves the trust level desired by TI 502 when performing Task-1. For example, if Task-1 is related to computing related operations, it may need certain CPU and memory resources. If Task-2 is related to communication related operations, it may need certain cellular uplink/downlink bandwidth resources. In the meantime, the resource requirements could be in various forms. For example, when Task-1 is related to communication-related operations, the resource requirements may specify what kind of communication interfaces need to be used, how much downlink and uplink bandwidth (or any other type of communication resources) needs to be allocated, the expected minimum/maximum sending/receiving data rates, etc. As another example, when Task-1 is related to computing-related operations, the resource requirements may specify what kinds of resources need to be used (such as CPU/memory/GPU/etc.), how much computing resources should be allocated, the expected minimum/maximum data processing speed, etc.

Note that 518 may also be periodically conducted after TP 504 starts executing Task-1 since Task-1's resource requirements may be dynamically changing due to various reasons, such as: the workload of Task-1 is changed; the desired trust level to be achieved by TP-1 is changed; the preferred trust evaluation criteria specified by TI 502 is changed. In this way, TP 504 may always allocate an appropriate amount of resources to Task-1 to maintain a stable and sufficient trust index desired by TI 502.

At 520, with resource requirements determined at 518, TP 504 may decide whether such resource requirements can be met or not. For example, if TP 504 currently has sufficient resources that are larger than the resource requirements determined at 518, TP 504 may decide to accept Task-1. Otherwise, TP 504 may not have sufficient resources for performing Task-1 and only the process at 524, in which TP 504 may send a rejection response to TI 502, indicating a reason, e.g. due to lack of resources, for the rejection.

At 522, assuming TP 504 may allocate sufficient resources to Task-1 at 520, TP 504 reviews the details in SC-1 and TP 504 may update or request modification of SC-1 if needed. For example, TP 504 may review the related policies or rules in SC-1 to see if any of the policies need to be adjusted. Also, TP 504 may update its own distributed ledger account/address in the SC-1. After that, TP 504 may sign the smart contract.

At 524, TP 504 sends an acknowledgement to TI 502 regarding Task-1. The acknowledgement which may include three types of responses: accepted, conditionally accepted, and rejected.

Accepted is to indicate that TP 504 accepts to execute Task-1 and will try to achieve the trust level desired by TI 502. Also, if TP 504 agrees with the current contents in SC-1, TI 502 may also sign SC-1 and SC-1 will be finalized.

Conditional accepted is to indicate that TP 504 could accept to execute Task-1 but certain parts of SC-1 need to be revised, which may be related to task execution instruction, trust evaluation criteria, or desired trust level as indicated by TI 502. For example, TP 504 may require an update to the task execution instruction (e.g. avoid too many high-overhead operations), the trust evaluation criteria (e.g. to modify a calculation algorithm for the trust index), and/or the desired trust level (e.g. TP 504 may ask TI-1 to specify a different trust level to be achieved), etc. In this case, TI 502 may need to further review the update made by TP 504. If TI 502 agrees, it will also sign on the SC-1 in order to finalize SC-1. Rejected is to indicate TP 504 cannot accept Task-1 for now and a potential reason may also be indicated.

At 526, in the case that TI 502 does not agree with the proposed updates made by TP 504 (as mentioned in 524, further negotiation between TP 504 and TI 502 can be conducted if needed until a consensus can be reached. After that, both of TI 502 and TP 504 may need to sign on SC-1 so that SC-1 could be finalized. In this process, 516-524 may be re-used.

At 528, TI 502 may send a smart contract deployment request to DLS 506, including the finalized SC-1 from 524 or 528. The parameters included in this request may include the following information. The identifier of the sender, such as TI 502. The purpose of the request, e.g. to record/deploy a smart contract, such as SC-1. The copy of the finalized smart contract, i.e. SC-1. The identifier of a distributed ledger system. This is to indicate where the smart contract should be recorded, for example, DLS 506. The identifier of a ledger. A distributed ledger system may include multiple ledgers, and this parameter is to indicate the smart contract should be recorded in which specific ledger. The distributed ledger account/address of the sender. Other stakeholder(s) of the smart contract, such as TP 502, TES 508, etc. The distributed ledger accounts/address(es) of other stakeholders. The contact addresses of all the stakeholders, such as the IP address or SUCI, FQDN, endpoint address, URL of TI 502, TP 504, TES 508, etc. An indication that whether other stakeholders should be notified by DLS 506 once the smart contract is successfully recorded. As an alternative, TI 502 does not have to indicate this parameter, and it is TI 502's responsibility to notify those stakeholders.

At 530, DLS 506 records SC-1 in a particular distributed ledger system as indicated by TI 502 528. Now, SC-1 is in place. At 532, DLS 506 sends an acknowledgement to TI 502 by indicating that SC-1 is recorded in a distributed ledger system and DLS 506 may also return the distributed ledger address of SC-1 to TI 502. As an alternative approach to 528-532, the finalized SC-1 could also be deployed by TP 504, or another management entity if exists, instead of TI 502.

Assuming DLS 506 did not notify other stakeholders as indicated at 528, TI 502 may need to notify them at 534. For example, TI 502 sends a notification to TP 504 about the successful recording of SC-1, along with the distributed ledger address of SC-1.

At 536, TP 504 may contact DLS 506 in order to validate SC-1's status. For example, based on the distributed ledger address of SC-1 sent from TI 502, TP 504 may validate such an address is valid and TP 504 may also retrieve SC-1 from this address in order to validate whether the contents of SC-1 is correct/finalized version, which has been signed by both TP 504 and TI 502.

At 538, TP 504 sends a response to TI 502 by indicating its awareness of SC-1's status. At 540, TP 504 starts to execute Task-1 based on SC-1. In particular, TP 504 may allocate an appropriate amount of resources to Task-1 as determine at 518.

At 542, TI 502 sends a trust evaluation request to TES 508 to evaluate TP 502's trust for performing Task-1. The following parameters may be included in this request. The identifier of TI who initiates the trust evaluation, such as TI 502. The identifier(s) of TP(s) whose trust needs to be evaluated by TES, e.g. TP 504. The task identifier, such as Task-1. A set of trust evaluation criteria preferred by TI 502. This was decided at 512. How frequently the trust evaluation may be conducted. For example, trust evaluation may be conducted periodically (e.g. in case Task-1 will be executed for a long time) or just one time (e.g. Task-1 can be done in a short time, and a single trust evaluation is needed after TP 50 4 completes the task).

In general, at 542, TI 502 may send a trust evaluation request to TES 508, which could initiate trust evaluation for multiple tasks at the same time (i.e. Task-1 may be just one of them). For example, TI 502 may want to initiate two trust evaluations, one is to evaluate the trust of TP 504 for performing Task-1, and the other one is to evaluate the trust of TP 504 for performing a different Task-2. Another example, TI 502 may want to initiate two trust evaluations, one is to evaluate the trust of TP 504 for performing Task-1, and the other one is to evaluate the trust of a different TP for performing a different Task-2. For each of trust evaluations to be initiated, the same set of parameters as listed above will be contained at 540, respectively.

At 544, TES 508 sends acknowledgement by indicating that it will conduct trust evaluation for TP-1. Details of TES 508 for processing the trust evaluation request sent from TI 502 may include the following. After receiving a trust evaluation request at 542, TES 508 may need to decide whether to approve this trust evaluation request sent from TI 502, in particular, TES 508 may need to decide whether trust evaluation is feasible or not. For example, by examining the trust evaluation criteria preferred by TI 502 sent at 542, TES 508 first understands what kind of data needs to be collected. Accordingly, TES 508 may decide for this particular trust evaluation (e.g. trust evaluation to be done on a specific TP), whether the data needed for trust evaluation “can” be collected. During the task execution, various runtime data may be captured, which describes how a TP is performing a task. Such data is useful for measuring the trust index of the TP for performing a task. The data used for trust evaluation may be collected from the TP itself. For example, if a task (e.g. Task-1) is related to communication-related operations, the following data can be collected from the TP, e.g. general information (including current connectivity status, current cellular signal strength, current serving base station, etc.) as well as task-specific information (including e.g. what communication interface is currently being used for executing Task-1, the current uplink/downlink data rates consumed by Task-1, etc.). Aa another example, if a task (e.g. Task-1) is related to computing-related operations, the following data can be collected from the TP, e.g. general information (including current CPU/memory capacities, CPU/memory workload, installed software, install security measures, etc.) as well as task-specific information (including e.g. CPU/memory resources allocated to Task-1, the average processing time cost of each computing request related to Task-1, how many computing requests related to Task-1 got accepted/rejected/delayed in the last five minutes, etc.). Other characteristic or context-related information may also be collected such as current location, work environment, mobility path, battery level, etc. In addition to TP itself, runtime data can also be provided by other data sources, such as various entities in the serving network of the TP, which may include various NFs in the 3GPP core network or the serving RAN nodes, etc. The existing 3GPP procedures related to data collection and network data analytics can be re-used for this purpose. For example, AMF could be data source, and various data can be collected from AMF such as number of UEs in an area of interest (which is helpful to know TP's current context).

It is possible that TP 504 has already indicated to TES 508 what kind of information can be collected from itself and/or from other data sources (such as the serving NFs of TP 504), e.g. due to prior interactions, Accordingly, based on this information, the TES may be able to decide whether the data needed for trust evaluation can be collected. Alternatively, in case TES 508 does not have such information, TES 508 may proactively contact TP 504 (as well as other data sources) in order to ask the TP 504 what kind of data can be collected from itself and/or from other involved entities. Then, the TES may initiate data collection with the TP 504 and other data sources. TP 504 may also instruct TES 508 regarding how to collect data from itself or from a serving NF if TES 508 does not know how to do that. For example, in case TES 508 needs to collect data related to TP 504 from its serving AMF, TES 506 may use existing Namf_EventExposure_Subscribe interface to interact with AMF.

If TES 508 decides that the data required for trust evaluation (using the trust evaluation criteria preferred by TI 502 as indicated at 542) can be collected, then TES 508 may determine that the trust evaluation to be conducted on TP 504 (required by TI 502) is feasible. Otherwise, it may mean the trust evaluation may not be feasible. For example, the trust evaluation required by TI 502 may need to use some specific data, which cannot be collected. If this is the case, TES 508 may decide that the trust evaluation required by TI 502 is not feasible. Then, during this process, TES 508 may need to send a response to TI 502 by indicating that the trust evaluation request was rejected. As a result, TI 502 may decide whether TP 504 should continue to conduct the task execution (but trust evaluation on TP 504 will not be conducted). Or TI 502 may want to cancel the task assignment of Task-1 to TP 504.

At 546, according to the instructions defined at 542, TES 508 conducts corresponding trust evaluations, e.g. by collecting necessary data and deriving the latest trust index of TP 504 for performing Task-1.

At 548. TES 508 sends a trigger to SC-1 via DLS 506 to report TP 502s latest trust level (this step may be repeated for multiple rounds if trust elevations need to be conducted periodically). TES 508 may also notify TI 502 about the latest trust level of TP 504. Here, TES 508 may also generate distributed ledger transaction(s) to store the trust evaluation result in distributed ledger system in order to support trust evaluation traceability (i.e. how trust evaluation was conducted). For example, when TES 508 conducts a new round of trust evaluation on TP 505, distributed ledger transaction(s) may be created to include one or more of the following information. When the trust evaluation was conducted. The identifier of the involved TP, such as TP 504. The identifier of the involved TI, such as TI 502. The identifier of the involved task, such as Task-1. The detailed information of Task-1, such as the GOT type and GOT sub type of Task-1. The adopted trust evaluation criteria, which was used by TES to evaluate the trust of TP 504 for performing Task-1. This could also be a link (such as an URL) where the latest trust evaluation criteria could be retrieved. The desired trust level that TI 502 expects TP 504 to achieve when performing Task-1. The actual trust level of TP 504, i.e. the trust that TP 504 currently is achieving, which is evaluated by TES 508. More detailed information may also be included. For example, the trust index of TP 504 may be calculated by a number of trust indicators, then the values and weights of those individual trust indicators may also be included. The potential workload/complexity of Task-1 specified by TI 502. The actual workload/complexity of Task-1 (e.g. collected from TP 504). The actual resources that have been allocated to Task-1 (e.g. collected from TP 504). The actual operation and execution contexts (such as current workload, resource capacity) of TP 504 when TP 504 is performing Task-1. Various data that was used by TES to calculate the actual trust level of TP 504. In case the data collected/used by TES is in a large size, the hashed data could be included in the transaction. Or, if the data was stored in a different location (other than distributed ledger system), a link could also be included in this parameter so that the data can be retrieved. Other data describing performance of the trust evaluation process, e.g. the time cost used by TES 508 to complete the new round of trust evaluation and the size of the data collected

The distributed ledger transactions including the evaluation results can be signed by TES 508 and recorded in the distributed ledger system. Those transactions could be used for various reasons. For example, certain data analytics could be conducted on those historical trust evaluation records in order to facilitate future task assignments. For example, those historical trust evaluation results can be used to estimate whether a TP may have a good potential (e.g. having sufficient trust) for performing a particular task.

At 548 SC-1 is triggered by the received trust index of TP 504. Accordingly, SC-1 will be executed, and the corresponding rewards/penalty is automatically settled between TI 502 and TP-1. An alternative is that TI 502 may draft SC-1 on its own and has already recorded SC-1 in the distributed ledger system. In other words, SC-1 may be pre-recorded and can be re-used. Accordingly, at 514, TI 502 may directly indicate the distributed ledger address of SC-1 to TP 504. Then, the process at 522-534 are not needed and TP 504 may just check SC-1 at 536 and decides whether it is willing to use the existing SC-1. If so, TP 504 may send an acknowledgement to TI 502 at 538 and start to execute the task at 540. This approach could accelerate the process for drafting, finalizing and deploying the smart contract. Note that, this alternative can also be applicable to the procedures proposed in the later sections.

The procedure shown in FIG. 5 may also be simplified in order to support the basic task assignment. In the basic task assignment, TI 502 may only indicate the workload and the resource requirements of Task-1, a set of desired trust evaluation criteria, and TI 502 may indicate the desired trust level that TI 502 expects TP 504 to achieve. In other words, in the basic task assignment, TP 504 may accept a task assignment without promising to achieve a certain trust level desired by TI 502. TP 504 may use a best effort approach to execute Task-1. However, TI 502 may still ask TES 506 to conduct trust evaluation on TP 504 and TES 508 may periodically generate latest trust index of TP 504 for performing the task and notify TI-1. For example, if TES 508 notifies TI 502 that TP 504 now has a low trust for performing Task-1, TI 502 may choose to ask TP 504 to terminate the execution of the Task-1. Overall, the following process of FIG. 5 may be modified in order to realize the basic task assignment.

At 512, all the parameters will be included except that TI 502 will not specify a desired trust level that TI 502 expects TP 504 to achieve when performing the task (e.g. Task-1). In the meantime, TI 502 may also specify resource requirements by itself (i.e. how many resources TI 502 requires TP 504 to allocate to Task-1), instead of letting TP 504 to decide that.

At 514, TI 502 could choose to establish a smart contract with TP 504 for the task assignment. In the smart contract, TI 502 will not specify a desired trust level that TI 502 expects TP 504 to achieve but specify resource requirements (such information may also be included in the distributed ledger transaction created at 548 if TES 508 also chooses to generate distributed ledger transaction(s) to store the trust evaluation results in distributed ledger system). TI 502 may specify resource requirements in any of ways. For example, when Task-1 is related to communication-related operations, the resource requirements may specify what kinds of communication interfaces need to be used, how much downlink and uplink bandwidth (or any other type of communication resources) should be allocated, the expected minimum/maximum sending/receiving data rates, etc. Another example, when Task-1 is related to computing-related operations, the resource requirements may specify what kinds of resources need to be used (such as CPU/memory/GPU/etc.), how much computing resources should be allocated, the expected minimum/maximum data processing speed, etc.

Alternatively, TI 502 may choose not to establish a smart contract with TP 504. Instead, TI 502 may just send all the parameters decided at 512 to TP 504 at 516.

The process at 518-522 may be simplified. For example, TP 504 may evaluate whether the resource requirements specified by TI 502 can be satisfied or not. If so, TI 502 may decide to accept the task assignment. The process at 524-538 and 550 may not be needed if TI 502 chose not to establish a smart contract with TP 504.

TI 502 may still ask TES 508 to conduct trust evaluation on TP 504 at 542. Once TES 508 produces a new trust index of TP 504, it may notify TI 502 (as well as other entities). TI 502 may also use subscribe/notify approach to receive notifications from TES 508. For example, TI 502 may require that when the trust index of TP 504 is above or below a certain threshold, a trust index notification needs to be sent to TI 502 (as well as other entities).

In addition, during trust evaluation, in addition to generating trust index, various other metadata may also be generated and can provide explanatory information, including but not limited to e.g. whose trust was evaluated (e.g. TP 504), on which aspect (e.g. about the trust of UE-1 for performing Task-1, providing a service, or acting a role, etc.), who conducted the trust evaluation (e.g. a specific TES instance), the latest trust index produced by TES 508, whether the trust evaluation result is accurate (e.g. which could be ranked by involved stakeholders, e.g. who consumed the trust index), etc. The above-mentioned useful information may be recorded in a secure and accessible medium (such as any traditional storage medium or distributed ledgers) in order to support trust management traceability.

In addition, step 540 may be executed immediately after step 522 in case Task-1 may be a time-critical task that needs to be executed by TP 504 immediately after TP 504 decides to accept Task-1. In this case, steps 522-536 may be performed in parallel with task execution.

Another solution described includes task replacement with a new type of TI-TI interaction to enable task replacement. This solution is described as a procedure of decentralized resource provisioning for 6G task assignment in case a TP may not have sufficient resources for executing a task and a task replacement is required. which can be useful when the TP does not have sufficient amount of required resources for the new task (e.g. Task-1) and task replacement may be needed. For example, when a TI assigns a new task to a TP, the TP may be short on resources for performing the new task. The TP may suggest a task replacement proposal to a first TI (e.g. to replace an existing Task-2 initiated by a second TI). The first TI 502 may interact with the second TI in order to establish a smart contract between two TIs that prescribes the details of the task replacement. Once the smart contract in place, the TP may conduct task replacement so that the resources previously-allocated to Task-2 can now be used for performing Task-1.

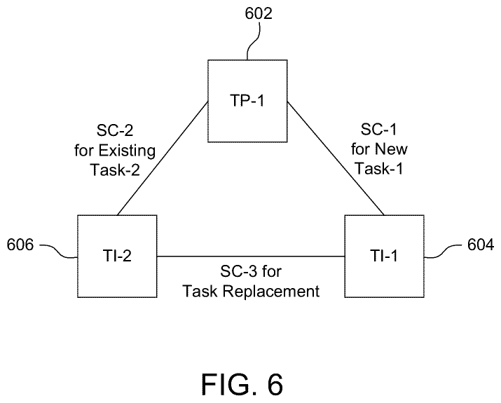

FIG. 6 illustrates an example of establishing a three smart contracts between three entities. In this example, SC-2 has already been established between TI 606 and TP 602, related to an on-going Task-2 executed by TP 602. SC-1 is to be established between TI 604 and TP 602 and is related to a new Task-1. SC-3 is to be established between two TIs (e.g. TI 604 and TI 606) in order to initiate a task replacement (e.g. Task-2 will be replaced by Task-1 so that the resources previously allocated to Task-2 can be reallocated to Task-1).

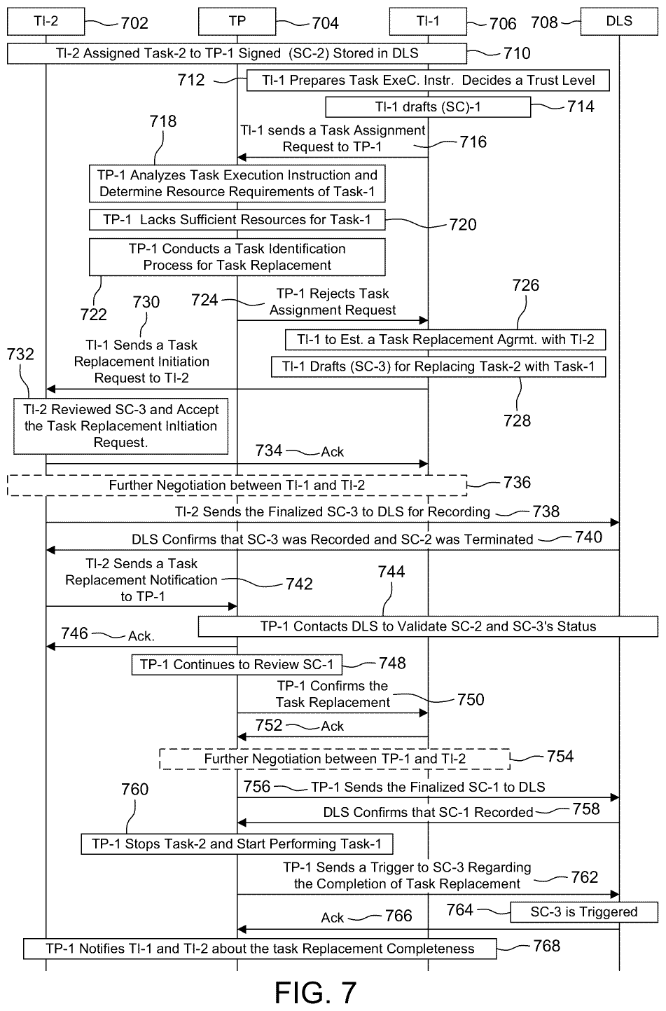

FIG. 7 illustrates an example process of decentralized resource provisioning for 6G assignment via task replacement process for task replacement with TI-TI interaction to enable the task replacement. In this example, as a precondition at 710, TI 702 has assigned Task-2 to TP 704. TI 702 and TP 704 executed a Smart Contract 2 (SC-2) stored in a DLS. DLS 708 is a service which manages different types of underlying distributed ledger systems.

The process at 712-718 are similar to the process at 512-518 in FIG. 5 and a diagram illustrating the relationships between different TIs/tasks and smart contracts is also shown in FIG. 5. In addition, another alternative solution at 716 is that TP 704 could publish its information to a distributed ledger, such as the current remaining resources of TP 704, what kind of existing tasks are currently executed by TP 704 and what are the corresponding TIs of those tasks. If TI 706 evaluates that TP 704 may not have sufficient resources for Task-1, TI 706 may directly require/request for task replacement at 716.

At 720, TP 704 finds it does not have sufficient resources for Task-1. In other words, the resources requirements derived at 718 cannot be met. For example, TP 704 may not have any available resources or TP 704 may still have some remaining free resources, but they are not sufficient for serving Task-1. As such, TP 704 needs to find more resources for Task-1 via task replacement.

At 722, TP 704 conducts a task identification process for task replacement. The purpose of this process is to identify a task that is currently being performed by TP 704 and may be replaced by Task-1 so that the resources allocated to the task can be re-allocated to Task-1. TP 704 may examine each of all on-going tasks that it is currently performing. TP 704 determines that a task (e.g. Task-2) is a good candidate for task replacement if the task meets one or more of the below similar requirements that are similar to those compared to Task-1. Note that, the below requirements are simply examples for illustrative purposes and various customized requirements may be defined based on business logic. Thus, the example process and requirements in the example process 700 should not be viewed as limiting in any aspect.

A GOT equalness or equality requirement may indicate that the GOT involved in the operation of Task-2 is the same as the GOT operation required by Task-1. In a stricter setting, the GOT subtype required by Task-2 may be as the same as the GOT subtype of Task-1.

Resource consumption similarity requirement may indicate that the resource requirement for performing Task-1 (as determined at 718) is equal or less than the resource amounts that were allocated to Task-2. This is to make sure the resource requirement of Task-1 may be met by recycling the resources allocated to Task-2.

Trust evaluation criteria similarity requirement may indicate that Task-2 may have already been performed by TP 704 for some time, and certain trust evaluations may have been conducted on TP 704. The trust evaluation on TP 704 for performing Task-2 may be based on a particular set of trust evaluation criteria desired by the initiator of Task-2 (i.e. a different TI, such as TI 702). TP 704 may compare the trust evaluation criteria desired by TI 706 and the trust evaluation criteria desired by TI 702 to see if they are similar or even the same. For example, two sets of criteria may be considered as similar if they focus on the same/similar set of trust indictors, or adopt the same/similar weights for those trust indicators, etc. If so, it means that TI 706 and TI 702 adopt similar trust evaluation criteria.

In case the trust evaluation criteria desired by TI 706 and the trust evaluation criteria desired by TI 702 are the same, TP 704 may further examine the historical trust evaluation records that reflect the practical trust levels of TP 704 for performing Task-2 in the past. Those records may be maintained by TP 704 locally, or by a TES, or stored in a storage system such as a distributed ledger system. TP 704 may aggregate those historical evaluation records and produce an average practical trust level of TP 704 for performing Task-2 (say value P). TP 704 may compare the value P with the value indicated in the “a specific trust level desired by TI 706” parameter in Step 3 (say value D, which is related to Task-1) to see if P>=D. If so, TP 704 may deduce that TP 704 should also have a good chance to achieve the sufficient trust (i.e. equal or larger than D) for performing Task-1. In this case, Task-2 is considered as a good candidate for task replacement. After identifying a task replacement candidate, TP 704 generates a task replacement proposal, which suggests replacing Task-2 with Task-1.

In case the trust evaluation criteria desired by TI 706 is less strict than the trust evaluation criteria desired by TI 702 (meaning that TP 704 may have a lower trust index for performing Task-2 due to a stricter trust elevation criteria), TP 704 may further examine the historical trust evaluation records that reflect the practical trust levels of TP 704 for performing Task-2 in the past. Those records may be maintained by TP 704 locally, or by a TES, or stored in a storage system such as a distributed ledger system. TP 704 may aggregate those historical evaluation records and produce an average practical trust level of TP 704 for performing Task-2 (say value P). TP 704 may compare the value P with the value indicated in the “a specific trust level desired by TI 706” parameter in Step 3 (say value D, which is related to Task-1) to see if P+Δ>=D (Here, Δ is a customized parameter and is a positive number for calibration). The reason is that by using the similar amount of resources, TP 704 may have a lower trust index for performing Task-2 due to stricter trust elevation criteria preferred by TI-2, so TP 704 should have a higher trust index for performing Task-1 if using the same amount of resources since TI 706 adopts a less strict trust evaluation criteria. TP 704 may deduce that TP 704 should also have a good chance to achieve the level of trust desired by TI 706 when performing Task-1 in case P+Δ>=D. In such a case, Task-2 is considered as a good candidate for task replacement. After identifying a task replacement candidate, TP 704 generates a task replacement proposal, which suggests replacing Task-2 with Task-1.

In case the trust evaluation criteria desired by TI 706 is stricter than the trust evaluation criteria desired by TI-2 (meaning that TP 704 may have a higher trust index for performing Task-2 due to less stricter trust elevation criteria), TP 704 may further examine the historical trust evaluation records that reflect the practical trust levels of TP 704 for performing Task-2 in the past. Those records may be maintained by TP 704 locally, or by a TES, or stored in a storage system such as a distributed ledger system. TP 704 may aggregate those historical evaluation records and produce an average practical trust level of TP 704 for performing Task-2 (say value P). TP 704 may compare the value P with the value indicated in the “a specific trust level desired by TI 706” parameter in Step 3 (say value D, which is related to Task-1) to see if P−Δ>=D (Here, Δ is a customized parameter and is a positive number for calibration). The reason is that by using the similar amount of resources, TP 704 may have a higher trust index for performing Task-2 due to less stricter trust elevation criteria preferred by TI-2, so TP 704 should have a lower trust index for performing Task-1 if using the same amount of resources since TI 706 adopts stricter trust evaluation criteria. TP 704 may deduce that TP 704 should also have a good chance to achieve the level of trust desired by TI 706 when performing Task-1 in case P−Δ>=D. In such a case, Task-2 is considered as a good candidate for task replacement. After identifying a task replacement candidate, TP 704 generates a task replacement proposal, which suggests replacing Task-2 with Task-1.

Other types of filtering criteria may also be adopted for identifying task replacement candidates, such as the importance of the task (e.g. a less important task may be a good candidate for task replacement), the importance or the priority of the associated TI (e.g. a task initiated by a less important TI may be a good candidate for task replacement), tasks that are about to end, etc.

In general, it is possible that two or more on-going tasks may be replaced by a single Task-1, i.e. all the resources previously-allocated to those on-going tasks may be re-allocated to the new Task-1. This is possible where multiple on-going tasks are not resource-consuming tasks while Task-1 is a heavy resource-consuming task that requires many resources. Reversely, another generalization is that it is possible that two or more new tasks may replace a single on-going task, i.e. all the resources previously-allocated to the single on-going task may be reallocated to one or more new tasks. This is possible where the single on-going tasks is a heavy resource-consuming task while new tasks are not resource-consuming tasks. In the above two generalized cases, a further generalization is that the smart contract can be established between more than two TIs. However, for easy illustration, the remaining steps assume that only one on-going task (Task-2) is to be replaced by one new task (i.e. Task-1) and only two TIs are involved.

At 724, TP 704 rejects task assignment request and returns a task replacement proposal to TI 706. The task replacement proposal to TI 706 may include the following parameters: the receiver of this task replacement proposal, e.g. TI 706; the identifier of the new task to be assigned, e.g. Task-1; the initiator of the new task, e.g. TI 706; the identifier of the involved TP which the new task is to be assigned to, such as TP 704; the identifier of another task (e.g. Task-2) to be replaced, e.g. Task-2. Such an identifier could be a globally unique identifier or a locally unique identifier. In a later step, TI 706 may contact TI-2 and use this identifier to indicate which task is to be replaced; the related TI of the task to be replaced, e.g. TI-2; the contract address or the identifier of TI-2, such as IP address, FQDN, SUCI, IMEI, endpoint address, URL, etc.

At 726, TI 706 decides to establish a task replacement agreement with TI-2, and at 728, TI 706 drafts a Smart Contract-3 (SC-3) for replacing Task-2 with Task-1. SC-3 may include the following parameters: the purpose of the smart contract, i.e. task replacement; the identifier of TI who initiates this task replacement, such as TI 706; the identifier of the new task to be assigned, e.g. Task-1, this is an optional parameter if TI 706 does not want to disclose this information; the identifier of the involved TP which the new task is to be assigned to, such as TP 704; the identifier of the task to be replaced, e.g. Task-2; the related TI of the task to be replaced, i.e. TI-2; the compensation that TI 706 would like to pay TI-2 if TI-2 agrees to stop or suspend the operation of Task-2 for now, additionally, TI 706 may also like to pay certain compensation to TP 704 since TP 704 is the entity for executing task replacement; the account or address of TI 706 in a distributed ledger system 708 (e.g. a blockchain address of TI 706); and any other policies/rules about task replacement.

At 730, TI 706 sends a task replacement initiation request to TI 702, along with drafted SC-3 (which is signed by TI 706). At 732, TI 702 reviews SC-3 and decides to accept the task replacement initiation request. For example, there are different reasons for TI 702 to accept the request. One reason could be that the Task-2 is not an important task and the compensation that TI 706 would like to pay TI 702 is attractive.

At 734, TI 702 sends an acknowledgement to TI 706 by indicating that it agrees with the task replacement proposal and would like to follow the agreement described in SC-3. SC-3 will also be signed by TI 702. TI 702 may also indicate to TI 706 that it will record the SC-3 in a distributed ledger system via DLS. At 736, further negotiation between TI 706 and TI 702 may be needed before finalizing SC-3. To implement this, iterations of the process at 738-740 may be used. Alternatively, TI 706 may also be responsible for recording the finalized SC-3 into distributed ledger system, i.e. the process at 738-740 may also be performed by TI 706 instead.

Note that it is also possible that TI 702 may reject the task replacement initiation request sent from TI 706. If that is the case, the processing after 734 may not be performed, meaning the current task replacement with TI 702 is not feasible and TI 706 may need to ask TP 704 for another task replacement proposal.

At 738, TI 702 sends the finalized SC-3 to DLS for recording, and also sends a trigger to disable/terminate SC-2. This request may include the following parameters: a smart contract to be recorded, such as the finalized SC-3; an identifier of a distributed ledger system and an identifier of a specific ledger, where the smart contract is to be recorded; an identifier of a smart contract to be disabled or terminated, such as the finalized SC-2; and an identifier of a distributed ledger system and an identifier of a specific ledger, where the smart contract is to be disabled or terminated.

At 740, DLS 708 confirms to TI 702 that SC-3 was recorded successfully, and SC-2 was terminated. Note that, although Task-2 and its associated SC-2 was terminated, such an event will not affect TP 704's reputation/trust since the termination of Task-2 was agreed by TI 702. As such, another distributed ledger transaction can be recorded in a distributed ledger system in order to record such an event if needed.

TI 702, at 742, sends a task replacement notification to TP 704 to trigger the task replacement execution (Alternatively, process 738-740, were conducted by TI 706, TI 706 send a task replacement notification to TP 704 at 742). TI 702 may indicate to TP 704 that SC-3 was recorded successfully, and SC-2 was already terminated. This request may include the following parameters: an indication that a task replacement should be conducted; the identifier of the new task to be assigned, e.g. Task-1; the initiator of the new task, such as TI 706; the identifier of the involved TP, i.e. where Task-1 shall be assigned to, such as TP 704; the identifier of the task to be replaced, such as Task-2; the initiator of the task to be replaced, such as TI 702; the status of the smart contract associated with task to be replaced (e.g. Task-2), such as SC-2, which was already disabled or terminated; the status of the smart contract related to task replacement agreement between two TIs (e.g. TI 706 and TI 702), such as SC-3, which already takes into effect; and an instruction of how to trigger the smart contract. For example, this parameter may indicate that once TP 704 completes the task replacement, it needs to create a specific transaction (as a trigger) and send it to SC-3 via DLS 708.

TP 704, at 744, contacts DLS 708 to validate SC-2 and SC-3's status. For example, TP 704 needs to make sure SC-2 was already terminated so that Task-2 now can be stopped. TP 704 also needs to make sure that SC-3 is already in effect, meaning that TI 706 and TI 702 already reach consensus on the task replacement, and the content of SC-3 is the correct/finalized version, which has been signed by both TI 706 and TI 702.

TP 704, at 746, sends an acknowledgement to TI 702 by indicating that task replacement execution will be started soon. At 748, TP 704 now has resources sufficient to execute for Task-1 with the required trust-index and TP 704 may continue to work with TI 706 to figure out how Task-1 should be executed (which is described in SC-1), which was received at 716 but was interrupted in at 718 due to lack of resources. Accordingly, TP 704 now continues to review the details in SC-1 and proposes updates to SC-1 if needed.

TP 704, at 750, confirms with TI 706 about the upcoming task replacement. In the meantime, TP 704 also sends an updated SC-1 to TI 706. At 752, TI 706 sends an acknowledgement to TP 704 for the upcoming task replacement.

Further negotiation between TP 704 and TI 706 may be needed before finalizing SC-1 at 754. To implement this the process at 750-752 and their variations may be re-used. For example, TI 706 may further review the updated smart contract sent from TP 704. TI 706 may agree with it or propose further updates. After that, TI 706 may send the updated smart contract to TP 704 for another round of review until consensus is reached.

At 756, TP 704 sends the finalized SC-1 to DLS 708 for recording. DLS 708, at 758, confirms to TP 704 that SC-1 was recorded successfully, meaning that SC-1 already takes into effect. Alternatively, TI 706 may be responsible for recording SC-1 in a distributed ledger system and notify TP 704 that the SC-1 has already been recorded.

TP 704 stops Task-2 and starts performing Task-1 using the resources previously-allocated to Task-2 at 760. Task replacement is complete. Note that, it is possible that Task-1 may be a time-critical task that needs to be executed by TP 704 immediately after it receives the task assignment from TI 706. If that is the case, process 760 may be conducted immediately (similar to medical service in an emergency room) after 722 (by assuming that TI 702 has indicated to TP 704 that its tasks can be replaced even without a formal task replacement smart contract being established). Then, process 724-758 (similar to post billing services after the emergency medical services are provided) may be conducted after process 760, i.e. during Task-1's execution. To further accelerate process 722, related to task identification for task replacement, TP 704 may conduct some pre-processing and maintain a list of task candidates for the future task replacement. The process/procedure described in this paragraph may also be applicable to any of the process/procedures described herein.

TP 704, at 762, sends a trigger to SC-3 via DLS 708 regarding the completion of task replacement. This request may include the following information: a distributed ledger address of the involved smart contract, such as SC-3; an event name, such as task replacement completion; the identifier of the new task, such as Task-1; the initiator of the new task, such as TI 706; the identifier of the involved TP, i.e. where task replacement was done, such as TP 704; the identifier of the task that has been replaced by the new task, such as Task-2; the initiator of the task that has been replaced, such as TI 702; and more detailed information about task replacement, e.g. how many resources have been recycled from Task-2 and reallocated to Task-1, the time cost of the task replacement process. This information may be sent to SC-3 and compared with rules/policies described in SC-3 so that SC-3 could automatically deduce how much compensation TI 706 should pay to TI 702 (as well as TP 704).

At 764, SC-3 is triggered, and the compensation is automatically transferred from TI 706 to TI 702 due to the completion of task replacement. DLS 708, at 766, sends an acknowledgement to TP 704 by indicating that SC-2 is executed. TP 704, at 768 notifies TI 706 and TI 702 about the task replacement completeness. After this, TP 704 may continue to execute Task-1 and the process in 542-550 illustrated in FIG. 5 may be applied.

In the above process, Task-2 and its associated SC-2 are fully terminated by TP 704 due to task replacement and all the resources allocated to Task-2 will be re-allocated to Task-1 (initiated by TI 706). In general, other types of resource re-allocation from Task-2 to Task-1 may also be adopted. For example, another approach is that Task-2 and its associated SC-2 does not have to be fully terminated. Accordingly, TI 706 and TI 702 may still sign a smart contract (e.g. SC-3) for resource sharing. For example, TI 702 may agree to reduce some resource consumption for Task-2, meaning that TP 704 may reduce the resource allocation to Task-2 and the saved resources can be re-allocated to Task-1. In this case, Task-2 will still be executed by TP 704 and it will not be fully terminated, but just be operated by TP 704 using a decreased amount of resources (accordingly, the original SC-2 may needs to be updated, but does not have to be terminated). In addition, TI 706 may have several ways to obtain certain compensations due to the termination of Task-2. For example, in addition to obtaining certain payment from TI 706 as described in smart contract SC-3, TP-1 may also give TI 702 a high-priority for future task assignment.

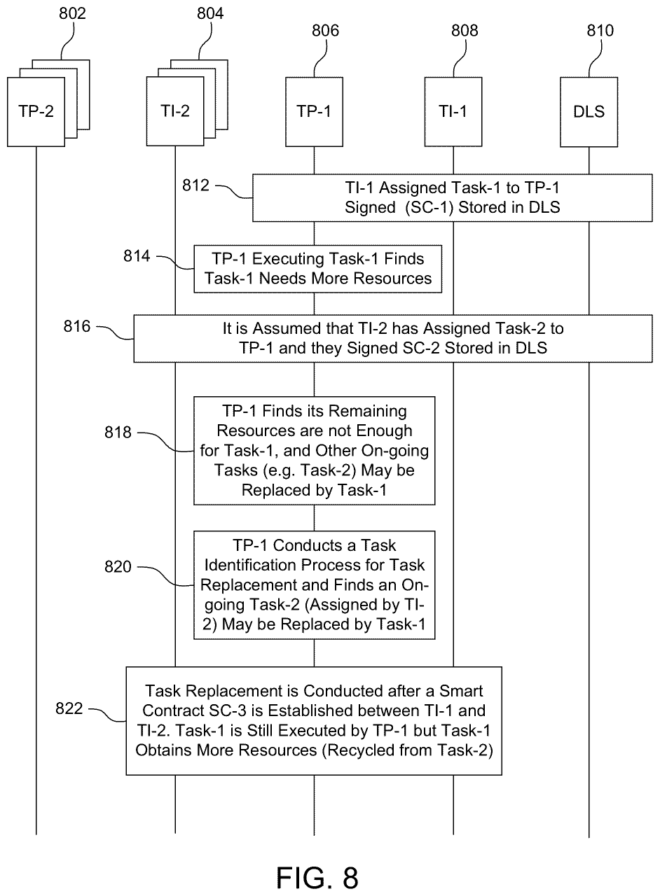

FIGS. 8-10 illustrate an example process of decentralized resource provisioning for 6G Task Assignment via Task Replacement and Task Migration according to an embodiment. The described process of decentralized resource provisioning for 6G task assignment may apply in cases where a TP may not have sufficient resources for executing a task and both task replacement and cross-TP task migration are needed.

This solution addresses an additional new type of TI-TI interaction for enabling migration-destination TP identification. In this solution, the resource provisioning and task replacement is initiated by a TP. For example, during task execution, a TP may need to handle certain dynamics and to re-adjust the resource allocation to Task-1 in order to maintain a sufficient trust index desired by TI. This solution utilizes task replacement similar to the process as described with reference to FIG. 7 and additionally utilizes task migration. For example, when an existing task (e.g. Task-1) requires more resources, the TP may use task replacement in order to find the additional resources needed for the task. However, in certain cases, the impacted task may have to be migrated to another TP (denoted as migration-destination TP). Described are several variations regarding how to identify a migration-destination TP. For example, the migration source TP may suggest a migration-destination TP to the corresponding TI of the task to be migrated, the corresponding TI of the task to be migrated may identify a migration-destination TP by itself and then notify the migration-source TP to start migration, and the corresponding TI of the task to be migrated may ask other TIs for help in order to identify a migration-destination TP (This is the second new type of TI-TI interaction, which is to enable migration-destination TP identification).

As a precondition, at 812, TI-1 808 has assigned Task-1 to TP-1 806 for execution, and they signed a Smart Contract-1 (SC-1) stored in DLS. DLS is a service which manages different types of underlying distributed ledger systems.

At 814, TP-1 806 has been executing Task-1 but now TP-1 806 finds Task-1 needs additional resources to maintain the trust level needed by TI-1 808. The reasons could be various, such as: the workload of Task-1 becomes larger, so that the resource requirements of Task-1 increases; TI-1 808 has increased its desired trust level, i.e. TI-1 808 expects TP-1 806 to execute Task-1 with a higher trust, for example, TI-1 808 may send a request to TP-1 806 by indicating the task identifier and an updated trust level desired by TI-1. The corresponding smart contract associated with Task-1 may also need to be updated, once TP-1 806 receives the updated trust level to be achieved, it may decide that more resources are needed; and TI-1 808 updates its trust evaluation criteria regarding how TP-1 806's trust should be evaluated (For example, TI-1 808 may send a request to TP-1 806 by indicating the task identifier, an updated trust evaluation criteria desired by TI-1. The corresponding smart contract associated with Task-1 may also need to be updated). Once TP-1 806 receives the updated trust evaluation criteria, TP-1 806 may analyze that more resources should be allocated to Task-1 so that TP-1 806 can still achieve the sufficient trust based on the new trust evaluation criteria. Overall, the process at 518 in FIG. 5 may be re-used in at 814 in order for TP-1 806 to dynamically evaluate the latest high-level needs (due to the various changes listed above) of Task-1 and transform into the specific amount of resources for Task-1. In particular, for a new resource requirement (e.g. Task-1 requires more resources), if TP-1 806 currently has sufficient available resources, TP-1 806 may directly allocate additional resources to Task-1. However, if TP-1 806 currently is short on resources (e.g. TP-1 806 has no free resources at all or the free resources are not enough for Task-1), there are three different cases regarding how to provision additional resources to Task-1 via task replacement and/or task migration.

FIG. 8 illustrates the process where an on-going Task-1 may obtain additional resources from TP-1 806 via task replacement. At 816, it is assumed that TI-2 804 has assigned Task-2 to TP-1 806, and they signed SC-2, which was previously stored in a distributed ledger system. At 818, TP-1 806 has some available resources remaining. However, even if all the remaining available resources are allocated to Task-1, it is not enough to meet its needed trust. Therefore, TP-1 806 needs to find more resources for Task-1. For example, Task-1 may replace one or more on-going tasks (e.g. Task-2) and the recycled resources can be reallocated to Task-1.

TP-1 806, at 820, conducts a task identification process for task replacement and finds one or more on-going tasks (e.g. Task-2 assigned by TI-2 804) may be replaced by Task-1. For ease of illustration, the remaining process assume that only one task (i.e. Task-2) will be replaced by Task-1.

At 822, task replacement is conducted after a smart contract (SC-3) is established between TI-1 808 and TI-2 804. For example, TI-1 808 may contact TI-2 804 in order to initiate the task replacement. If TI-2 804 agrees to do so, a new smart contract (SC-3) can be established. TP-1 806 may be informed once SC-3 is recorded in a distributed ledger system and takes into effect. Then, TP-1 806 could execute the task replacement by terminating Task-2 (and the associated SC-2) and then reallocating the resources to Task-1. Overall, Step 5a can be implemented by reusing Steps 8-28 in FIG. 6. After the task replacement, Task-1 can be executed by TP-1 806 with more resources (which were recycled from Task-2). In addition, in case Task-1 is a time-critical task, Task-1 may be executed by TP-1 806 immediately by terminating Task-2 even before SC-3 is established, the details in Step 25 of FIG. 6 can also be applicable to this step.

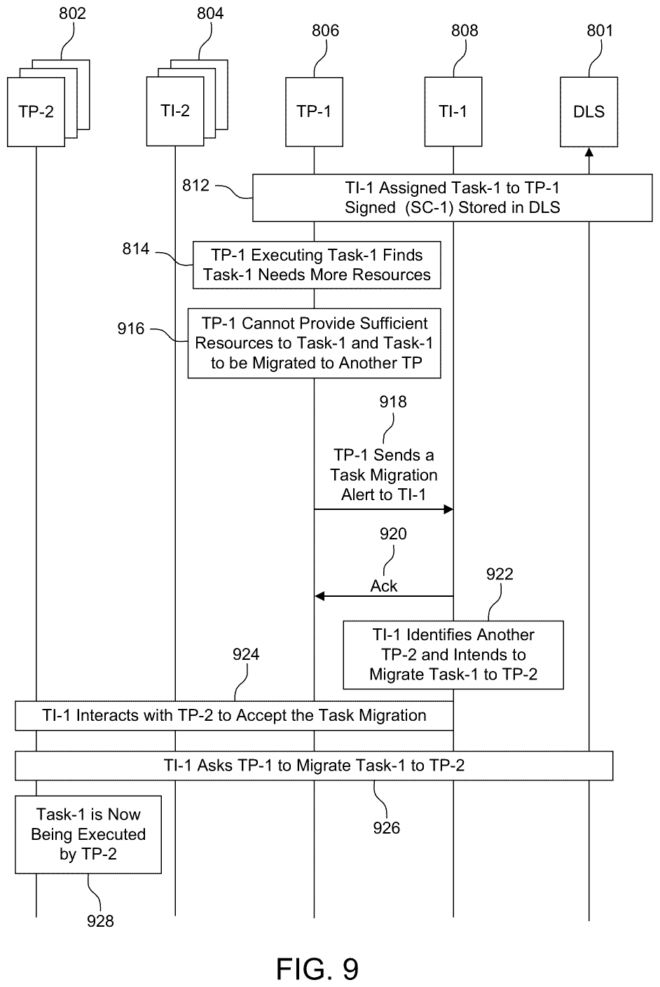

FIG. 9 illustrates an example process of decentralized resource provisioning for 6G Task Assignment via Task Replacement and Task Migration according to an embodiment. The process similar to the process in FIG. 8 but includes the case where an on-going Task-1 needs to be migrated from TP-1 806 to a different TP (e.g. TP-2 802, which is discovered by TI-1 808). At 916, TP-1 806 finds Task-1 needs to be migrated to another TP. The reason may be because the new resource requirement of Task-1 is larger than the maximum resource capacity of TP-1 806. Therefore, Task-1 may have to be migrated to another TP for execution. TP-1 806, at 918, sends a task migration alert to TI-1. The following parameter may be included in this request: an indication that a task migration should be conducted; the identifier of the task to be migrated, e.g. Task-1; the initiator of the task to be migrated, such as TI-1; the identifier of the migration-origin TP, from where the task is to be migrated, such as TP-1 806; and the identifier of migration-destination TP where the task is to be migrated, such as TP-2 802. This is an optional parameter, meaning that TP-1 806 may not have the intelligence to suggest a migration-destination TP. If this parameter is present, the process at 922 may not be needed.

TI-1 808, at 920, sends an acknowledgement to TP-1 806 for the task migration request. If TP-1 806 did not indicate a migration-destination TP at 918, TI-1 808, at 922, needs to identify a migration-destination TP by itself. For example, TI-1 808 identifies TP-2 802 and intends to migrate Task-1 to TP-2 802.

At 924, TI-1 808 asks TP-2 802 to accept the task migration. For example, TI-1 808 may first send a task migration request to TP-2 802, in which all the parameters included at 512 of FIG. 5 may be included. TP-2 802 may accept the migration request in two scenarios.

In a first scenario, TP-2 802 currently has sufficient resources for executing Task-1. The detailed processing is as follows: TP-2 802 may first evaluate the latest resource requirements of Task-1, then TP-2 802 finds that its available resources are sufficient (process 518-520 in FIG. 5 can be re-used). As a result, TI-1 808 and TP-2 802 may establish a new smart contract (e.g. SC-4) since TP-2 802 will now be responsible for executing Task-1. In order to do so, process 522-542 of FIG. 5 may be re-used.

In a scenario, TP-2 802 currently does not have sufficient resources for executing Task-1 and a task replacement on TP-2 802 is needed. The detailed processing is as follows: TP-2 802 may first evaluate the latest resource requirements of Task-1, then TP-2 802 finds that its remaining available resources are not sufficient (process 518-520 of FIG. 5 may be re-used). TP-2 802 may then propose a task replacement proposal to TI-1 808. The proposal may indicate that one or more on-going tasks (e.g. Task-2, which was assigned to TP-2 802 by another TI-2 804) may be replaced in order to facilitate Task-1's migration. In other words, once Task-1 is migrated to TP-2 802, Task-2 may be terminated by TP-2 802 and the resources used by Task-2 will be re-allocated to Task-1. TI-1 808 and TI-2 804 may need to establish a new smart contract (e.g. SC-5) for task replacement on TP-2 802. To realize this whole process, process 722-746 of FIG. 7 may be re-used.

After process 924, at 926 TP-2 802 is ready to accept Task-1. Accordingly, TI-1 808 asks TP-1 806 to start migrating Task-1 to TP-2 802. For example, TP-2 802 may set up a new working instance of Task-1 based on the task description-related parameters received at 924. In the meantime, TP-1 806 may transfer all the runtime data to TP-2 802 (e.g. context data, session data related to Task-1). Any existing approach for software/session migration may be leveraged. In addition, SC-1 should also be terminated since SC-1 was established between TI-1 808 and TP-1 806, but TP-1 806 will not execute Task-1 after task migration. In addition, it is possible that Task-1 is a time-critical task and needs to be migrated to TP-2 802 immediately. Several approaches may be used to accelerate the task migration. For example, in the first scenario, TI-1 808 may identify TP-2 802 earlier, e.g. even before Task-1 needs to be migrated. The smart contract (i.e. SC-4) between TI-1 808 and TP-2 802 may also be established earlier if feasible. The second approach is that Task-1 could be migrated to TP-2 802 immediately, but the smart contract SC-4 could be established at a later time, in this case, immediate task migration is similar to emergency medical service in emergency room while smart contract establishment is similar to subsequent billing process. The details of this step may also be used in other processes if applicable. At 928, Task-1 is now being executed by TP-2 802 and task migration is complete.

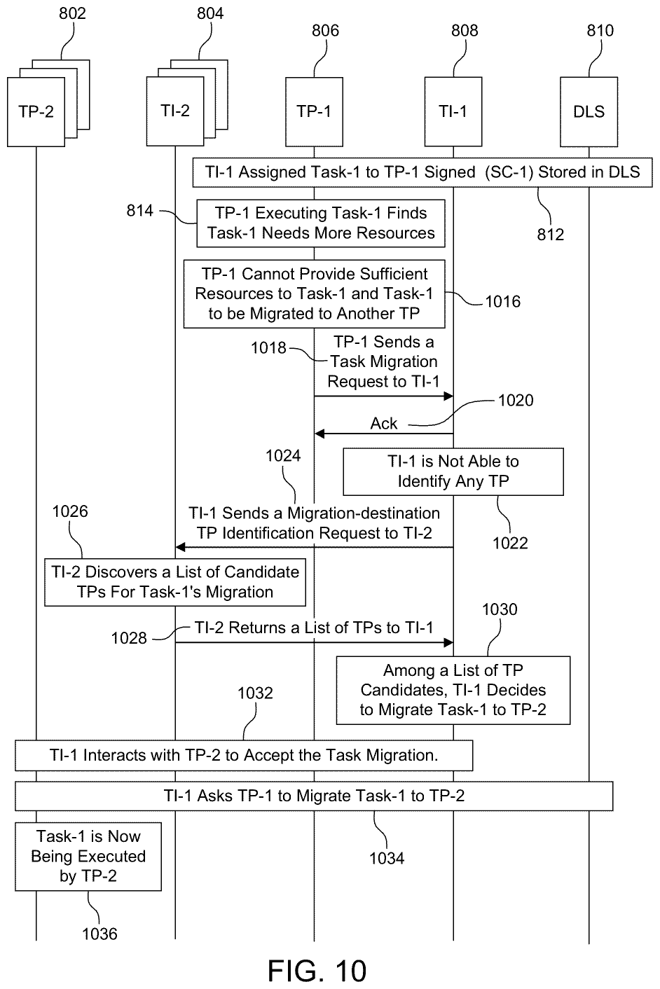

FIG. 10 illustrates an example process of decentralized resource provisioning for 6G Task Assignment via Task Replacement and Task Migration according to an embodiment. The process similar to the process in FIG. 9 but an on-going Task-1 needs to be migrated from TP-1 806 to a different TP (e.g. TP-2 802, where TP-2 802 is identified via TI interaction).

The process at 1016-1020 may be similar to the process at 916-922 in FIG. 9. In addition, it is assumed that at 1018, TP-1 806 did not indicate any migration-destination TP to TI-1 808. At 1022, TI-1 808 needs to identify a migration-destination TP by itself. However, TI-1 808 is not able to do so. The reasons could be: TI-1 808 has the limited TP identification capabilities and cannot identify any desired TP for task migration; and TI-1 808 does not have privileges for conducting TP identification. Therefore, TI-1 808 may ask other TIs for help. For example, it is assumed that TI-1 808 and TI-2 804 know each other, or they belong to the same organization. Therefore, TI-1 808 may rely on TI-2 804 to identity a TP for task migration.

At 1024, TI-1 808 sends a migration-destination TP identification request to TI-2 804. This request may include the following parameters: an indication that TP identification is needed; the identifier of the task to be migrated, e.g. Task-1; and a detailed description of Task-1. For example, all the parameters included in 512 of FIG. 5 can also be included in this step.

At 1026, it is assumed that TI-2 804 knows a number of TPs due to past interactions. For example, TI-2 804 has assigned tasks to those TPs or TI-2 804 has some prior knowledge about those TPs. After this, TI-2 804 may create a list of migration-destination TP candidates.

TI-2 804, at 1028, returns a list of migration-destination TP candidates to TI-1. Among a list of candidates, TI-1 808, at 1030, decides a final selection. For example, TI-1 808 decides to migrate Task-1 to TP-2 802.

TI-1 808, at 1032, asks TP-2 802 to accept the task migration. TI-1 808 may send a task migration request to TP-2 802. TP-2 802 may agree to task migration based on two cases: TP-2 802 currently has sufficient resources for executing Task-1 and is willing to execute Task-1; or TP-2 802 currently does not have sufficient resources for executing Task-1 but task replacement(s) on TP-2 802 may be feasible so that Task-1 can be migrated to TP-2 802 by replacing one or more ongoing tasks currently-executed by TP-2 802.

1034 is similar to 926 of FIG. 9. After 1032, TP-2 802 is ready to accept Task-1, and at 1034 TI-1 808 asks TP-1 to start migrating Task-1 to TP-2 802. TI-1 808 also asks DLS to terminate SC-1. At 1036, Task-1 is now being executed by TP-2 802 and task migration is complete.

In the description that follows, a specific solution generalization and extension are discussed. For ease of illustration, a specific solution generalization and extension may only focus on one specific aspect. However, it is worth noting that all the solution generalizations and extensions described may be used at the same time, i.e. they can be combined and integrated in any number of ways.

A general solution with extensions related to Task Aggregation and Trust Index Aggregation is described. Task aggregation may include cases as follows.

A first Task-Aggregation case may apply to a scenario where task aggregation happens in a single TP. For example, a TP may need to conduct a complex or an aggregated task, which may be constituted by a number of individual tasks (e.g. each individual task requires the TP to conduct a specific type of GOT operations). One of the examples may be that in a service-based architecture, the TP is a service provider and running a service instance or a network function which provide certain service(s). Accordingly, a service consumer may send a request to the TP by calling the service-based API exposed by the TP, in order to ask TP to provide certain service(s). The TP may process the request and then return the corresponding response to the service consumer. For example, in an AI/ML data collection application, a TP may expose a “data capture and pre-processing service,” which could capture desired data using TP's on-board sensors, and then pre-process the data using the processing approaches desired/indicated by a service consumer. In this example, a service consumer may send a request to the TP by calling the “data capture and pre-processing service” API which contains input parameters related to what kinds of data should be captured and what pre-processing approach should be adopted. Once the request is received, the TP may process the request including capturing the desired data and conducting the desired pre-processing. After that, the TP as the service provider will return the pre-processed data to the service consumer in a response message. In the above example, running a “data capture and pre-processing service” may be modeled as a complex task, which is constituted by three individual tasks: Task-1, Task-2, and Task-3. Note that, two scenarios are possible. In one scenario, a TI is different from the consumer, the TI may only do task assignment for the three tasks. Once the tasks are assigned and the TP starts to execute the tasks, then the TP may serve consumers. In another scenario, an entity could be both a TI and a consumer. In this case, the TI may assign three tasks to the TP. Once the TP starts to execute the tasks, the TI can act as a consumer and send service access requests to the TP as described above.

Task-1 may involve GOT-1 operations (i.e. communication-related operations) as defined in this disclosure. For example, this task would require the TP (serving as a service provider) to receive request(s) from a service consumer and return a response to the consumers via communication channel (e.g. supported by a wireless cellular link). Note that, although it is not in the scope of discussion here, it is worth mentioning that a counterpart task may also be assigned to the consumer (e.g. acting as TI-1), which may initiate and send request(s) to TP-1 and receive response(s) from TP-1.

Task-2 may involve GOT-3 operations (i.e. sensing-related operations) as defined in this disclosure. For example, this task would require the TP (serving as a service provider) to capture the desired data using its on-board sensors.

Task-3 may involve GOT-2 operations (i.e. computing-related operations) as defined in this disclosure. For example, this task would require the TP (serving as a service provider) to pre-process the data captured from on-board sensors.

A second Task-Aggregation case may apply to a scenario where task aggregation happens across different TPs. In this case, a complex or an aggregated task (which may be constituted by a number of individual tasks and each individual task requires the TP to conduct a specific type of GOT operations) may be jointly conducted by multiple TPs. Still using the AI/ML data capture and preprocessing example discussed in the first Task-Aggregation case with certain modifications. Here, it is assumed that two TPs are involved. TP-1 is a service provider and running a service instance or a network function related to data capture and pre-processing. Accordingly, a service consumer may send a request by calling the service-based API exposed by TP-1, in order to ask TP-1 to provide the service. However, TP-1 may only have the capability to capture raw data from its on-board sensors and TP-1 does not have the capability to conduct data pre-processing. However, another TP-2 is also a service provider and running a service instance or a network function related to data preprocessing. Accordingly, when TP-1 is serving the request received from a consumer, TP-1 may further act as a consumer and sends a request by calling the service-based API exposed by TP-2 (in which the captured data and desired pre-processing approaches are indicated), in order to ask TP-2 to pre-process the data captured by TP-1. TP-2 may process the request and then return the pre-processed data to TP-1 in a response. Last, TP-1 may further return a response to the original service consumer, in which the pre-processed data is included. In this example, operating a “data capture and pre-processing service” can also be modeled as a complex task, which is constituted by four individual tasks: Task-1, Task-2, Task-3, and Task-4.

Task-1 (conducted by TP-1) may involve GOT-1 operations (i.e. communication-related operations) as defined in the description. For example, this task would require TP-1 (serving as a service provider) to receive request(s) from a service consumer and return a response to the consumer.

Task-2 (conducted by TP-1) may involve GOT-3 operations (i.e. sensing-related operations) as defined in the description. For example, this task would require TP-1 (serving as a service provider) to capture the desired data using its on-board sensors.

Task-3 (conducted by TP-2) may involve GOT-1 operations (i.e. communication-related operations) as defined in the description. For example, this task would require TP-2 (serving as a service provider) to receive request(s) from a service consumer and return a response to the consumer.

Task-4 (conducted by TP-2) may involve GOT-2 operations (i.e. computing-related operations) as defined in the description. For example, this task would require the TP (serving as a service provider) to pre-process the data sent from a consumer (e.g. TP-1).

Accordingly, proposed solutions described may also applicable to the scenarios where trust index aggregation is needed. Trust index aggregation may have cases as follows.

Trust-Index-Aggregation-Case-1 may correspond to Task-Aggregation-Case-1, where task aggregation happens in a single TP. In this case, a TP may need to conduct a complex or an aggregated task, which may be constituted by a number of individual tasks (e.g. each individual task requires the TP to conduct a specific type of GOT operations). Still taking the same example as discussed in the first Task-Aggregation, in an AI/ML data collection application, a TP may expose a “data capture and pre-processing service”, which can be implemented by assigning three tasks to the TP (i.e. Task-1, Task-2, and Task-3 as discussed in the first Task-Aggregation case. In particular, the TP may have a corresponding trust index associated with each task, which describes the trust level of the TP when performing a specific task. However, it is proposed that the due to task aggregation, the trust index of different tasks can also be aggregated. For example, the trust indexes of TP for performing Task-1, Task-2 and Task-3 (as discussed) can also be aggregated and the aggregated trust index can be regarded as the trust index of the TP for providing the “data capture and pre-processing service” (which was modeled as a complex task). In the meantime, the weight setting for trust index aggregation may depend on specific application scenarios. In a simple example, the trust indexes associated with Task-1, Task-2 and Task-3 may have the same weight when they are aggregated, i.e. each has 33.33% weight. Alternatively, in certain cases, it is possible that the communication channel between the service consumer and service provider (i.e. the TP) are pretty good (i.e. never causing any issue and can be fully trusted). In such a case, the trust index of the TP for performing Task-1, which requires the TP to conduct communication-related operations, e.g. receiving requests from service consumers and returning responses to them, can be set to only take a very small weight during trust index aggregation (e.g. 5% or even 0%), meaning that the trust of “data capture and pre-processing service” will be mainly decided by Task-2 and Task-3.

Trust-Index-Aggregation-Case-2: This corresponds to the second Task-Aggregation case, where task aggregation happens across different TPs. In this case, a complex or an aggregated task, which may be constituted by a number of individual tasks and each individual task requires a TP to conduct a specific type of GOT operations, may be jointly conducted by multiple TPs. Still taking the same example as discussed in the second Task-Aggregation case, in an AI/ML data collection application, TP-1 may expose a “data capture and pre-processing service,” which may be implemented by assigning four tasks to two TPs, i.e. TP-1 and TP-2 (e.g. as discussed in the second Task-Aggregation case, Task-1 and Task-2 are assigned to TP-1 while Task-3 and Task-4 are assigned to TP-2). In this case, due to cross-TP task aggregation, cross-TP trust index aggregation can also be supported. For example, the trust indexes of TP-1 for performing Task-1 and Task-2 can be aggregated with the trust indexes of TP-2 for performing Task-3 and Task-4. In other words, such a trust index aggregation uses the trust indexes of different TPs. However, from a service consumer's perspective (who sends service requests to TP-1), it does not care about the trust of individual TPs. Instead, it may only care about whether the service can be trusted. Therefore, the cross-TP trust aggregation and the aggregated trust index can be regarded as the trust index of the whole “data capture and pre-processing service,” which was modeled as a complex task and was jointly operated by TP-1 and TP-2. Alternatively, since TP-1 is the endpoint entity exposing the “data capture and pre-processing service” to consumers (i.e. receiving requests from consumers), such an aggregated trust indexes can also be associated with TP-1, which indicates the trust of TP-1 for providing the service. In other words, the details of how the service is operated may be transparent to the consumers, i.e. the consumers of TP-1 may not be aware of the existence of TP-2.

The generalization regarding task aggregation and trust index aggregation as proposed above can be applicable to all of the proposed procedures described. For example, the procedure shown in FIG. 5 may have the following generalization so that task aggregation and trust indexes aggregation can be applied or supported.

In the first generalization of FIG. 5, it assumes that a complex task is constituted by a number of individual tasks, which will be assigned to a single TP, i.e. TP 504. Still taking the same example as discussed in Task-Aggregation-Case-1, TP 504 acts as a service provider and may expose/provide a “data capture and pre-processing service”, which is a complex task and can be implemented by assigning three individual tasks to TP 504 (e.g. Task-1, Task-2, and Task-3 as discussed in the Task-Aggregation-Case-1).

At 512 of FIG. 5, the generalization of this step is that TI 502 may assign a complex task to TP 504 and the complex task is constituted by a number of individual tasks.

TI 502 may directly define a detailed execution guideline of how to conduct the complex task. Taking the same example as discussed in Task-Aggregation-Case-1, TI 502 intends to assign three tasks (Task-1, Task-2 and Task-3) to TP 504 so that TP 504 could provide the “data capture and pre-processing service” (as a complex task). The task execution guideline may specify that providing data capture and pre-processing service require TP 504 to perform three tasks (i.e. (Task-1, Task-2 and Task-3). For Task-1, TI 502 may define the message formats (such as API interface specification), communication protocol to be used for the request/response messaging between TP 504 (acting as a service provider) and its service consumers. This allows the service consumers to communicate with TP 504 using standard interfaces, such as service-based API call when interacting with TP 504. In the meantime, TI 502 may also specify the detailed operation guide for Task-2 and Task-3. For example, TI 502 may prescribe that once TP 504 receives a request from a service consumer for accessing the service, TP 504 needs to conduct Task-2 and Task-3 in order to process the request and the processed result will be returned to the service consumer in a response.

TI 502 may also specify a set of preferred trust evaluation criteria, which indicates how the trust of TP 504 should be evaluated when TP 504 is executing the complex task. In particular, for each individual task contained in the complex task, TI 502 may specify which trust indicator(s) shall be considered and how to set their weights when calculating the trust index of TP 504 for performing each individual task. In addition, TI 502 may also specify how to aggregate the trust indexes of TP 504 for performing each individual task in order to calculate an aggregate trust index, which describes the trust of TP 504 for performing the whole complex task, i.e. the service. For example, it is possible that TP 504 may have a high trust level for Task-2 and Task-3 since TP 504 have excellent computing and sensing resources for conducting Task-2 and Task-3, but TP 504 may have a low trust index level since TP 504 currently may only have very limited communication resources for conducting Task-1. All those trust indexes associated with three tasks may contribute to the aggregated trust index, which reflects the overall trust level of TP 504 for providing the service.

TI 502 may also specify a desired trust level associated with the complex task, which indicates what kinds of trust TI 502 expects TP 504 to achieve when TP 504 is performing the complex task (i.e. providing a service). In other words, here the desired trust level specified by TI 502 is related to the aggregated trust index of TP 504 for performing the complex task.

At 516 of FIG. 5, TI 502 may send a task assignment request to TP 504, along with a drafted smart contract SC-1. The generalization of this step is that the task assignment could be related to a complex task, which is constituted by a number of individual tasks as generalized at 512. The smart contract (SC-1 in Step 3) may also be generalized so that the smart contract is used to prescribe the details regarding how TP 504 should conduct the complex task.

At 520 of FIG. 5, the generalization of this step is that TP 504 may examine the task assignment sent from TI 502 (regarding a complex task) and decide the resource requirements of each individual tasks contained in the complex task. For example, TP 504 may examine each individual task and decide the corresponding resource requirement for each individual task respectively. The sum of the resource requirement of each individual task will be the aggregated as the total resource requirements for the complex task.

At 542 of FIG. 5, the generalization of this step is that trust evaluation on TP 504 could also be on the complex task-level. For example, TI 502 may also send a trust evaluation request to TES 508 and ask TES 508 to evaluate TP 504's trust for performing the complex task, along with a set of preferred trust evaluation criteria desired by TI 502 regarding how TES should evaluate the trust of TP 504 for performing the complex task. At 548 of FIG. 5, the generalization of this step is that the trust elevation result may contain the aggregated trust indexes of TP 504, which describes the trust of TP 504 for performing the complex task.

In the second generalization of FIG. 5, it is assumed that a complex task is constituted by a number of individual tasks, which will be assigned to multiple TPs, e.g. TP 504 and TP-2. Still taking the same example as discussed in Task-Aggregation-Case-2, TP 504 acts as a service provider and may expose/provide a “data capture and pre-processing service”, which is a complex task and can be implemented by assigning four individual tasks to two TPs (e.g. as discussed in the Task-Aggregation-Case-2, Task-1 and Task-2 are assigned to TP-1 while Task-3 and Task-4 are assigned to TP-2).

Task assignments could be conducted in two ways. In approach-1. TI 502 only sends the task assignment request to TP 504 and it is TP 504's responsibility to further send the task assignments to other involved TPs, such as TP-2 (which is not shown in the FIG. 5). The generalization of FIG. 5 using approach-1 are described as follows.

At 512 of FIG. 5, the generalization is similar to the generation discussed in the first generalization of FIG. 5, but the major difference is that TI 502 may further decide which individual tasks should be assigned to which other TPs. Also, a smart contract SC-1 will be drafted for the complex task. Since the complex task contains a number of individual tasks to be conducted by different TPs (such as TP-1 and TP-2 in the example discussed in Task-Aggregation-Case-2), the smart contract SC-1 may also be established between TI 502 and multiple TPs (such as TP-1 and TP-2 in the example). In addition, this time the aggregated trust index is associated with the complex task, which is constituted by a number of individual tasks executed by multiple TPs. Therefore, TI 502 may indicate that the aggregated trust index associated with the complex task will be calculated by aggregating the trust indexes of different TPs. For example, since TP 504 is to conduct Task-1 and Task-2, the two trust indexes of TP 504 will be used: one is the trust index of TP 504 for performing Task-1 while the other trust index is the trust index of TP 504 for performing Task-2. Similarly, TP-2 is to conduct Task-3 and Task-4, the two trust indexes of TP-2 will be used: one is the trust index of TP-2 for performing Task-3 while the other trust index is the trust index of TP-2 for performing Task-4. As a result, the aggregated trust index associated with the complex task will be calculated by aggregating the four trust indexes (two are related to TP 504 and the other two are related to TP-2).

At 516 of FIG. 5, the generalization of this step is that TI 502 may send a task assignment request to TP 504 about the complex task. More than that, TI 502 may indicate that the individual tasks contained in the complex tasks is to be conducted by multiple TPs (e.g. by TP 504 and TP-2). An additional step needs to added is that once TP 504 receives the task assignment request sent from TI 502, TP 504 may adjust and further forward task assignment requests to all the involved TPs. Still taking the same example as discussed in Task-Aggregation-Case-2, TP 504 is assigned with Task-1 and Task-2. TP 504 also learns that Task-3 and Task-4 should be assigned to TP-2. Accordingly, TP 504 may further adjust and forward a task assignment request to TP-2, which assigns Task-3 and Task-4 to TP-2.

All the involved TPs (e.g. TP-1 and TP-2) will conduct the process 518-522 of FIG. 5 respectively based on what kind of tasks have been assigned to them and then report to TP 504 and whether they could accept the task assignments. Still taking the same example as discussed in Task-Aggregation-Case-2, TP 504 conducts process 518-522 in order to decide whether it can accept Task-1 and Task-2. Similarly, TP-2 will also conduct process 518-522 for Task-3 and Task-4. After that, TP-2 will report to TP 504 that whether the task assignment (related to Task-3 and Task-4) are accepted or not. If all the individual tasks contained in a complex task are accepted by the involved TPs, it means that the complex task can be jointly conducted.

At 542 of FIG. 5, the generalization of this step is that TI 502 may also send a trust evaluation request to TES and ask TES to calculate the aggregated trust associated with the complex task, along with a set of preferred trust evaluation criteria desired by TI 502 regarding how TES 508 should calculate the aggregated trust. For example, this time, the aggregated trust index may be calculated by aggregating four trust indexes of different TPs, e.g. two trust indexes of TP 504 for performing Task-1 and Task-2 and two trust indexes of TP-2 for performing Task-3 and Task-4.

At 548 of FIG. 5, the generalization of this step is that the trust elevation result may contain the aggregated trust indexes associated with the complex task, which is jointly conducted by multiple TPs.

In a second approach, approach-2. TI 502 will send individual task assignment requests to each of involved TPs and the first generalization of FIG. 5 can be re-used. Still taking the same example as discussed in Task-Aggregation-Case-2, TI 502 may send a task assignment request to TP 504 in order to assign Task-1 and Task-2. Similarly, TI 502 may send another task assignment request to TP-2 in order to assign Task-3 and Task-4. In the meantime, each of involved TP will conduct process 518-522 of FIG. 5 receptively to decide the resource requirement of each task and whether it can be accepted or not. If all the individual task contained in the complex task can be accepted by corresponding TPs, it means the complex task can be jointly conducted.

Task aggregation may also have an impact to the procedure shown in FIG. 7 and FIGS. 8-10 and the corresponding embodiments described. For example, at 722 of FIG. 7, TP 704 conducts a task identification process for task replacement. The purpose of this process is to identify a task that is currently being performed by TP 704 and can be replaced by Task-1 so that the resources allocated to the task can be re-allocated to Task-1. TP 704 may examine each of all on-going tasks being performed by itself. For example, TP 704 determines that a task (e.g. Task-2) is a good candidate for task replacement. Note that, it is possible that Task-2 may be one of the individual tasks of a complex task. If so, at 738 of FIG. 7, once Task-2 is terminated, its belonging complex task may also be interrupted due to the termination of Task-2. If that is the case, at 738 of FIG. 7, in addition to terminating Task-2 for enabling task replacement, all other individual tasks contained in the same complex task (as Task-2) may also be terminated if needed unless those individual tasks can continue to operate for other purposes.

Another extension of the procedures shown in FIG. 5 (which may be applicable to all the procedures described) is that not only that TI 502 can specify a desired trust level that TI 502 expects TP 504 to achieve, in the other way, TP 504 may also specify a desired trust level that TP 504 expects TI 502 (or another involved entity) to achieve during the task execution. For example, if TI 502 fails to achieve the trust level desired by TP 504 while Task-1 is being executed by TP 504, TP 504 may temporarily pause or terminate the execution of Task-1. To realize this extension, at 522 TP 504 may further add the following information three elements into SC-1. First, TP 504 may specify a set of trust evaluation criteria based on its personalized need, which defines how TI 502's trust should be evaluated (This may be different from how TI 502 wants to evaluate TP 504's trust, which may be more related to task execution). For example, TI 502′ trust may be measured based on the latest reputation of TI 502 (e.g. whether TI 502 has any bad behavior, e.g. whether TI 502 was involved in recent fraudulent or malicious activities. Another example, TI 502′ trust may be measured based on TI 502's latest financial credit score, e.g. whether TI 502 has any new late-payment activity, etc. Second, a desired trust level that TP 504 expects TI 502 to achieve, based on the preferred trust elevation criteria specified by TP 504. Third, various policy or rules regarding how the execution of Task-1 may be affected by the trust of TI 502. At 546, TES 508 may not only conduct trust evaluation on TP 504 (based on the trust evaluation criteria specified by TI 502), but may also conduct trust evaluation on TI 502 (based on the trust evaluation criteria specified by TP 504). For example, if based on TES 508's evaluation, TI 502's trust is below the desired trust level specified by TP 504, TP 504 may choose to pause, or even terminate the operation of Task-1. The trust evaluation results of both TP 504 and TI 502 may be sent to SC-1 at 548 in order to trigger the execution of SC-1 at 548. In addition, the trust evaluation results of both TP 504 and TI 502 may also be sent to TI 502 and TP 504 respectively, so that certain reactive actions may be conducted (e.g. TP 504 may choose to pause the execution of Task-1 temporarily if it is notified that TI 502's latest trust is below a desired trust level specified by TP 504). Also, another related extension is the trust evaluation result generated at 548 may also be stored in the distributed ledger system as ledger transactions. A trust evaluation result of a TI may indicate the following information, including but not limited to the current trust level of the TI (e.g. a trust index value) and how the trust was evaluated, e.g. based on credit score or recent behaviors, etc.

Another extension is that, the procedure proposed in FIG. 5 can also be used in another scenario different from the task assignment process. It is assumed that TP 504 is executing a task (e.g. Task-1), e.g. Task-1 was assigned to TP 504 by a management entity or TP 504 was pre-configured to execute Task-1 and no trust-related requirements have been posed to TP 504. As an example, it is assumed that Task-1 requires TP 504 to run a service or a network function (as a service provider) so that service consumers may send service requests to TP 504 for processing. In other words, in this scenario, the role of TI will be replaced with the role of a “consumer” of TP 504 (as a service provider). In particular, it will be the consumer entity to specify trust-related needs when it intends to consume the service provided by TP 504. For example, processing the service requests sent from a consumer is realized by the execution of Task-1, i.e. running a software function and conducting processing. Therefore, the procedure shown in FIG. 5 may have the modifications as described.

As a pre-condition, it is assumed that TP 504 is already executing Task-1 and TP 504 is now a service provider and can accept service requests from consumers. TI 502 in FIG. 5 will be replaced with Consumer-1, which may be served by TP 504 by executing Task-1.

Process 516 will be changed so that Consumer-1 may send a first service request to TP 504 in order to require the needed service provided by TP 504, which is associated with Task-1. In other words, process 516 is no longer related to a task assignment. Accordingly, at 516 all the existing parameters may still be included except the task execution guideline regarding how Task-1 should be conducted since now Consumer-1 is just a service consumer. In the meantime, Consumer-1 may still need to indicate a potential workload to be incurred, e.g. the workload or the estimated difficulty/complexity for TP 504 to serve the service requests to be sent from Consumer-1. This determines the amount of resources TP 504 may need to allocate to Task-1 in order to meet the needs of Consumer-1 when serving or processing the requests sent from Consumer-1. For example, Consumer-1 may indicate how long it wants to use the service provided by TP 504, which is associated with Task-1 (e.g. one hour), and in each of time internal (e.g. every ten minutes), how many requests are expected to be sent from Consumer-1 that need to be processed by TP 504. More importantly, Consumer-1 may also specify two sets of parameters regarding high-level trust needs. One set of parameters are related to how Consumer-1 intends to evaluate the trust of TP 504 when TP 504 is serving the service requests from Consumer-1 that are processed by TP by executing Task-1. This information may also be sent from Consumer-1 to TES 508 at 542. A second set of parameters are related to a desired trust level that Consumer-1 expects TP 504 to achieve when TP 504 is serving the requests sent from Consumer-1.

In addition, the generalization and extension described above may also be used here. For example, Consumer-1 may not only specify a trust level that Consumer-1 expects TP 504 to achieve when TP 504 is serving Consumer-1, but also TP 504 may specify a trust level that TP 504 expects Consumer-1 to achieve when TP 504 is serving Consumer-1. TES 508 may conduct trust evaluation on both TP 504 and Consumer-1 while TP 504 is serving Consumer-1. The trust evaluation results of both TP 504 and Consumer-1 may also be stored in the distributed ledger systems.

Another extension is that the solutions proposed in this disclosure often involve with processes such as 542-548 of FIG. 5 related to a requesting entity, which could be any entity such as a TI, a TP, a service consumer of a TP, asking TES 508 to conduct trust evaluation on a target entity, which could also be any entity such as a TP or a TI. It is suggested that depending on how TES 508 is implemented, “interacting with TES” may be realized in different ways. For example, the requesting entity may have direct messaging with TES using request/response mode or using subscribe/notify mode. Or, the requesting entity may have indirect messaging with TES, e.g. via a proxy, or via intermediated medium (such as a distributed ledger). Overall, the TES could be implemented in different ways, including but not limited to: TES could be implemented as a native 3GPP function, e.g. as a new Network Function (NF) in the core network, a new function inside the access network of the 3GPP system, or implemented as an enhanced feature of an existing NF in 3GPP cellular system, such as 5G network data analytics function (NWDAF) and/or the Security Function deployed by the mobile operator. TES may be implemented as a new ETSI PDL platform service. TES may be implemented as an individual smart contract specifically designed for providing trust evaluation services, which could be deployed in a distributed ledger system (in this case, messaging with TES such as requests/responses will be embodied as distributed ledger transactions). With this approach the TES smart contract could be re-used for conducting trust evaluation on any TP/TI/etc. and for any future needs. Another approach is that the functionality of TES (i.e. conducting data collection and calculating trust index) may be implemented in the same smart contract established between a specific TI and TP for resource provisioning such as the smart contract SC-1, which is established between TI 502 and TP 504 in FIG. 5 and is for resource provisioning purpose. If that is the case, the process at 542-548 are not needed. SC-1 may collect data from any involved entity based on its implementation details. Then, SC-1 could conduct trust evaluation and generate the trust index based on which SC-1 may automatically decide the corresponding rewards/penalty to be settled between TI 502 and TP 504 (as performed at 550 of in FIG. 5). It should be appreciated that this generalization may also be applicable to other concepts and/or solutions as described.

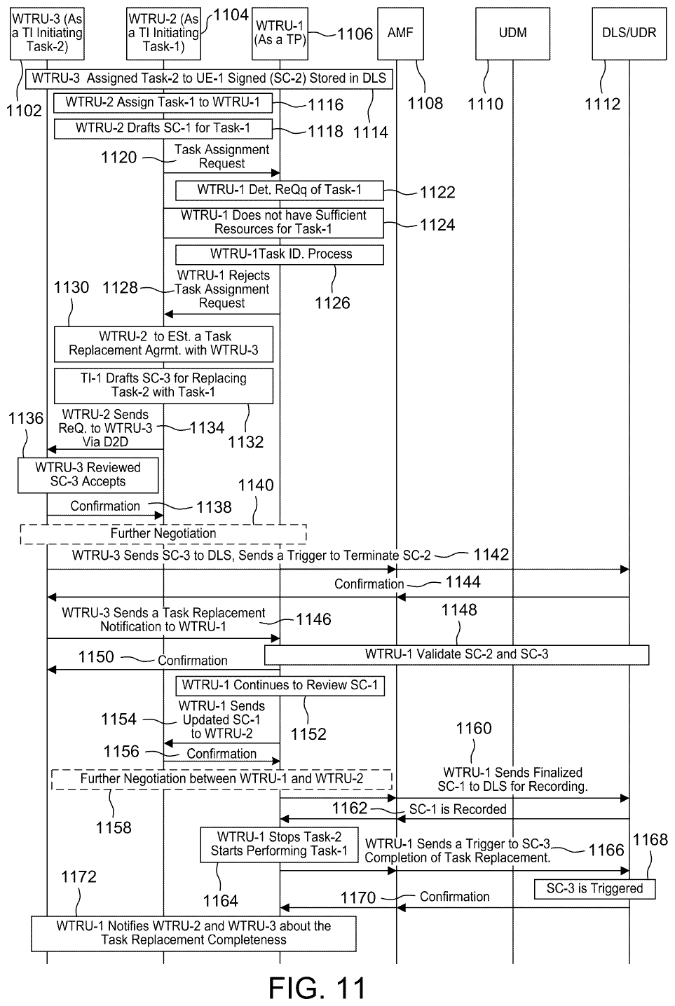

FIG. 11 illustrates a process of decentralized resource provisioning for 6G assignment via task replacement in a 3GPP architecture with 3GPP procedures. The process illustrated in FIG. 11 is similar to the process illustrated in FIG. 7 with the TI and TP entities being replaced with WTRUs and includes and AMF and UDM.

TI-1 (706) in FIG. 7 is implemented as a 3GPP WTRU (e.g. WTRU-2 1104) in FIG. 11. In addition to that, TI-1 may also be any entity in the network or in an application server.

TI-2 702 in FIG. 7 is implemented as a 3GPP WTRU (e.g. WTRU-3 1102) in FIG. 8. WTRU-1 1106 and WTRU-3 1102 may communicate with each other using e.g. D2D communication. In addition to that, TI-2 may also be any entity in the network or in an application server.

TP 704 in FIG. 7 is implemented as a 3GPP WTRU (e.g. WTRU-1 1106) in FIG. 8. In addition to that, TP-1 may also be any entity in the network or in an application server.

The DLS could be a new 3GPP network function in the core network, or part of UDR 1112. The process at 1114-1172 of FIG. 11 correspond with the process at 710-768 of FIG. 7.

The entities as described herein may be implemented in or correspond with entities of functions of a 3GPP network. A TI maybe implemented as a Vertical Application Layer (VAL) Client hosted on a 3GPP WTRU. Alternatively, a TI may be implemented as a new type of Service Enabler Architecture Layer for Verticals (SEAL) Client hosted on a 3GPP FIG. 7. Accordingly, a new SEAL service for decentralized and resource provisioning may be realized.

A TP maybe implemented as a VAL Server hosted on a 3GPP FIG. 7. Alternatively, a TP may be implemented as a new type of SEAL Server hosted on a 3GPP UE (for supporting decentralized resource provisioning).

DLS could be realized using a Client/Server architecture. Each WTRU may host a DLS client (when needed) which may allow a WTRU to interact with a DLS server on the network side. For example, the TP (as a VAL client or a SEAL client) hosted on a WTRU may rely on its DLS client hosted on the same WTRU in order to interact with the DLS server, which is the major entity to provide various blockchain capabilities (such as submitting new transactions or access existing transactions to an underlying blockchain system).

In addition, The entities as described herein may be implemented in or correspond with entities of functions of a ETSI PDL. For example, a DLS can be implemented as a DLE within a WTRU. A TI can be implemented as a PDL request originator (e.g. PDL service consumer) or a DLE, and a TP can be implemented as a PDL service provider or a DLE.

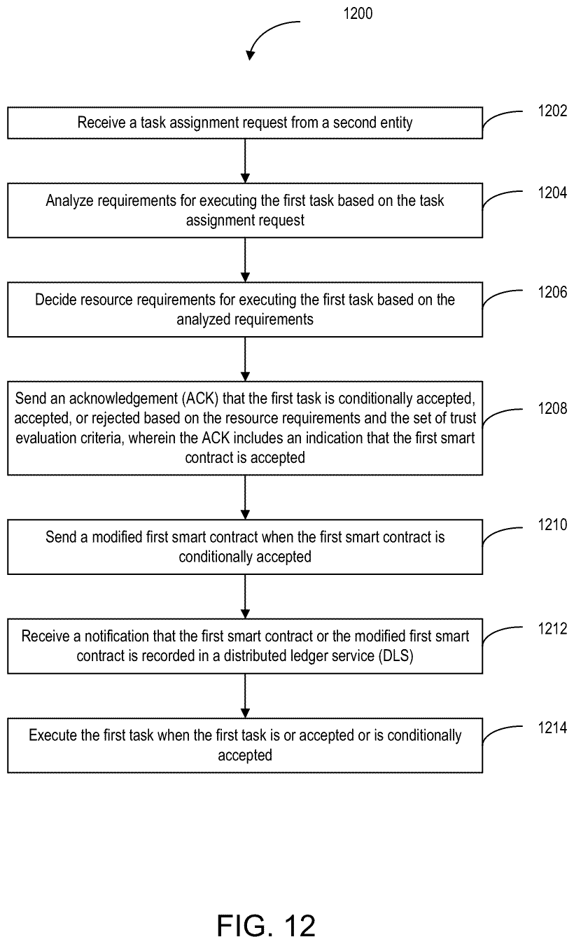

FIG. 12 is a flowchart of an example process 1200. In some implementations, one or more process blocks of FIG. 12 may be performed by an entity.

As shown in FIG. 12, process 1200 may include receiving a task assignment request from a second entity, the task assignment request including one or more of: an identifier of a first task, identifier of the second entity, an identifier of the first entity, execution instructions, set of trust evaluation criteria adopted, a first smart contract, an expected trust level specified by the second entity, a drafted first smart contract, and a preferred DLS at 1202. For example, a first entity may receive a task assignment request from a second entity, the task assignment request including one or more of: an identifier of a first task, identifier of the second entity, an identifier of the first entity, execution instructions, set of trust evaluation criteria adopted, a first smart contract, an expected trust level specified by the second entity, a drafted first smart contract, and a preferred DLS, as described above. As also shown in FIG. 12, process 1200 may include analyzing requirements for executing the first task based on the task assignment request at 1204. For example, first entity may analyze requirements for executing the first task based on the task assignment request, as described above. As further shown in FIG. 12, process 1200 may include deciding resource requirements for executing the first task based on the analyzed requirements at 1206. For example, the first entity may decide resource requirements for executing the first task based on the analyzed requirements, as described above. As also shown in FIG. 12, process 1200 may include sending an acknowledgement (ACK) that the first task is conditionally accepted, accepted, or rejected based on the resource requirements and the set of trust evaluation criteria, where the ACK includes an indication that the first smart contract is accepted at 1208. For example, the first entity may send an ACK that the first task is conditionally accepted, accepted, or rejected based on the resource requirements and the set of trust evaluation criteria, where the ack includes an indication that the first smart contract is accepted, as described above. As further shown in FIG. 12, process 1200 may include sending a modified first smart contract when the first smart contract is conditionally accepted at 1210. For example, the first entity may send a modified first smart contract when the first smart contract is conditionally accepted, as described above. As also shown in FIG. 12, process 1200 may include receiving a notification that the first smart contract or the modified first smart contract is recorded in a distributed ledger system at 1212. For example, the first entity may receive a notification that the first smart contract or the modified first smart contract is recorded in a distributed ledger system, as described above. As further shown in FIG. 12, process 1200 may include executing the first task when the first task is or accepted or is conditionally accepted at 1214. For example, the first entity may execute the first task when the first task is or accepted or is conditionally accepted, as described above.

Process 1200 may include additional implementations, such as any single implementation or any combination of implementations described below and/or in connection with one or more other processes described elsewhere herein. A first implementation, process 1200 may include confirming a validation status of the first smart contract with a DLS prior to executing the first task.

In a second implementation, alone or in combination with the first implementation, the instructions for executing the first task include one or more of: a first task identifier, a generic operation type (GOT), a GOT subtype, first task execution guidelines, description of the first task complexity, an indication of whether the first task can be stopped and replaced while the first task is being executed, and first task execution triggers.

In a third implementation, alone or in combination with the first and second implementation, the set of trust evaluation criteria specifies one or more: types of trust indicators considered, algorithms adopted for calculating respective types of trust indicators and a corresponding trust index, and parameter value configurations.

A fourth implementation, alone or in combination with one or more of the first through third implementations, process 1200 may include analyzing terms of the first smart contract, where the terms of the first smart contract include one or more of: an identifier of the first task, an identifier of the second entity, a corresponding distributed ledger account and/or address of the second entity, and identifier of the first entity, a corresponding distributed ledger account and/or address of the first entity, specific execution instructions for the first task, a set trust evaluation criteria adopted, the expected trust level specified by the second entity, and clauses, terms, policies of the first smart contract.

A fifth implementation, alone or in combination with one or more of the first through fourth implementations, process 1200 may include determining there are insufficient resources for executing the first task; identifying one or more ongoing second tasks corresponding to a second smart contract with a third entity that may be replaced by the first task; sending a task replacement proposal to the second entity; receiving a task replacement notification from the third entity, the task replacement indicating that a third smart contract is established between the second entity and the third entity; requesting, from the DLS, a validation that the second smart contract is terminated and the third smart is in effect; confirming the task replacement with the second entity and sending an updated first smart contract to the second entity; receiving an ACK from the second entity confirming task replacement; sending a finalized first smart contract to the DLS for recording; receiving, from the DLS, an ACK that the finalized first smart contract is recorded; and ending the second task with the third entity and performing the first task with the second entity using resources previously-allocated to second task.

In a sixth implementation, alone or in combination with one or more of the first through fifth implementations, the third entity is an UE, WTRU, network element, smart device, or IoT device hosting a software application or storing executable instructions which cause a specific task to be performed.

A seventh implementation, alone or in combination with one or more of the first through sixth implementations, process 1200 may include determining the first task should be migrated to a fourth entity; sending a task migration alert to the second entity; receiving an ACK of the task migration alert; receiving, from the second entity, a request to migrate the first task to the fourth entity; and migrating the first task to the fourth entity.

In an eighth implementation, alone or in combination with one or more of the first through seventh implementations, the fourth entity is an UE, WTRU, network element, smart device, or IoT device hosting a software application or storing executable instructions which cause a specific task to be performed.

In a ninth implementation, alone or in combination with one or more of the first through eighth implementations, first entity is a wireless transmit/receive unit (WTRU), a network element, a smart device, or an internet of things (IoT) device, and where the second entity is an UE, WTRU, network element, smart device, or IoT device hosting a software application or storing executable instructions which cause a specific task to be performed.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

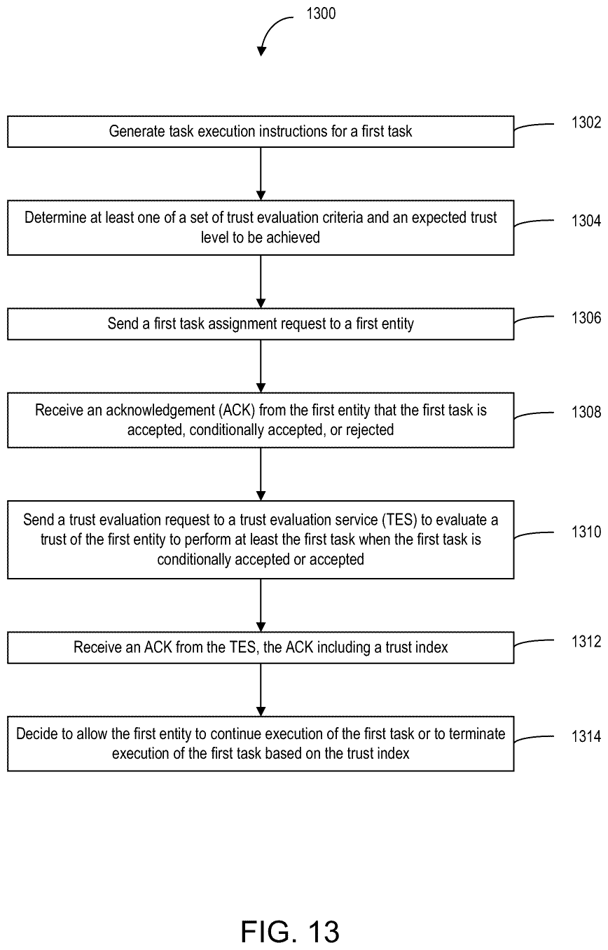

FIG. 13 is a flowchart of an example process 1300. In some implementations, one or more process blocks of FIG. 13 may be performed by a second entity.

As shown in FIG. 13, process 1300 may include generating task execution instructions for a first task at 1302. For example, the second entity may generate task execution instructions for a first task, as described above. As also shown in FIG. 13, process 1300 may include determining at least one of a set of trust evaluation criteria and an expected trust level to be achieved at 1304. For example, the second entity may determine at least one of a set of trust evaluation criteria and an expected trust level to be achieved, as described above. As further shown in FIG. 13, process 1300 may include sending a first task assignment request to a first entity, the first task assignment including one or more of: an identifier of the first task, an identifier of the first entity, an identifier of the second entity, the execution instructions for the first task, a set of trust evaluation criteria adopted, a trust level specified by the second entity, a first smart contract, and a preferred DLS at 1306. For example, the second entity may send a first task assignment request to a first entity, the first task assignment including one or more of: an identifier of the first task, an identifier of the first entity, an identifier of the second entity, the execution instructions for the first task, a set of trust evaluation criteria adopted, a trust level specified by the second entity, a first smart contract, and a preferred DLS, as described above. As also shown in FIG. 13, process 1300 may include receiving an acknowledgement (ACK) from the first entity that the first task is accepted, conditionally accepted, or rejected at 1308. For example, the second entity may receive an ACK from the first entity that the first task is accepted, conditionally accepted, or rejected, as described above. As further shown in FIG. 13, process 1300 may include sending a trust evaluation request to a trust evaluation service (TES) to evaluate a trust of the first entity to perform at least the first task when the first task is conditionally accepted or accepted at 1310. For example, the second entity may send a trust evaluation request to a TES to evaluate a trust of the first entity to perform at least the first task when the first task is conditionally accepted or accepted, as described above. As also shown in FIG. 13, process 1300 may include receiving an ACK from the TES, the ACK including a trust index at 1312. For example, the second entity may receive an ACK from the TES, the ACK including a trust index, alternatively, TES may send notifications including the latest trust index in a periodical manner, as described above. As further shown in FIG. 13, process 1300 may include deciding to allow the first entity to continue execution of the first task or to terminate execution of the first task based on the trust index at 1314. For example, the second entity may decide to allow the first entity to continue execution of the first task or to terminate execution of the first task based on the trust index, as described above.

Process 1300 may include additional implementations, such as any single implementation or any combination of implementations described below and/or in connection with one or more other processes described elsewhere herein. A first implementation, process 1300 further includes sending a first smart contract deployment request to a DLS including a finalized first smart contract when the first entity and the second entity agree to the finalized first smart contract; receiving an ACK from the DLS; and sending, to the first entity a notification indicating a successful recording of the first smart contract.

In a second implementation, alone or in combination with the first implementation, the first smart contract includes one or more of: an identifier of the first task, an identifier of the second entity, a corresponding distributed ledger account and/or address of the second entity, and identifier of the first entity, a corresponding distributed ledger account and/or address of the first entity, specific task instructions for the first task, a set trust evaluation criteria adopted, a trust level specified by the second entity, and clauses, terms, and policies specified for the first task.

A third implementation, alone or in combination with the first and second implementation, process 1300 further includes receiving a task replacement proposal request from the first entity when the first entity is executing a second task with a third entity, has a second smart contract corresponding to the second task stored in the DLS, and does not have sufficient resources for the execution of the first task or continued execution of the first task; deciding to establish a task replacement with the third entity; generating a third smart contract to replace the second task with the first task; sending a task replacement initiation request including the third smart contract to the third entity; receiving, from the third entity, an ACK of the task replacement initiation request and an agreement to accept the task replacement; and receiving, from the first entity, a notification of task replacement complete.

A fourth implementation, alone or in combination with one or more of the first through third implementations, process 1300 further includes receiving a task migration request from the first entity when determining it cannot provide sufficient resources for the first task; sending an ACK of the task migration request; sending a migration destination entity identification request to a third entity; receiving a list of destination entity candidates from the third entity; selecting a fourth entity from the list of destination entity candidates to migrate the first task; sending a request to the fourth entity to accept the migration of the first task; and sending a migration request to the first entity to migrate the first task to the fourth entity after the fourth entity agrees to accept the migration of the first task.

In a fifth implementation, alone or in combination with one or more of the first through fourth implementations, the first task execution instructions include one or more of: a first task identifier, at least one generic operation type (GOT), at least one GOT subtype, execution guidelines, a description of task complexity, an indication of whether a task can be stopped and replaced while a first entity is executing a task, and task execution triggers.

In a sixth implementation, alone or in combination with one or more of the first through fifth implementations, the set of trust evaluation criteria specifies one or more of: type of trust indicator (TIDC) for performing the first task, algorithms adopted for calculating a trust index (TIndex) of respective type of TIDC and a specified trust level.

In a seventh implementation, alone or in combination with one or more of the first through sixth implementations, the first entity is a wireless transmit/receive unit (WTRU), a network element, a smart device, or an internet of things (IoT) device.

In an eighth implementation, alone or in combination with one or more of the first through seventh implementations, the second entity is an UE, WTRU, network element, smart device, or IoT device hosting a software application or storing executable instructions which cause a specific task to be performed.

Although FIG. 13 shows example blocks of process 1300, in some implementations, process 1300 may include additional blocks, fewer blocks, different blocks, or differently arranged blocks than those depicted in FIG. 13. Additionally, or alternatively, two or more of the blocks of process 1300 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented in a first entity, the method comprising:
receiving a task assignment request from a second entity, the task assignment request including one or more of: an identifier of a first task, an identifier of the second entity, an identifier of the first entity, execution instructions, set of trust evaluation criteria adopted, a first smart contract, an expected trust level specified by the second entity, a drafted first smart contract, and a preferred DLS
analyzing requirements for executing the first task based on the task assignment request;
deciding resource requirements for executing the first task based on the analyzed requirements;
sending an acknowledgement (ACK) that the first task is conditionally accepted, accepted, or rejected based on the resource requirements and the set of trust evaluation criteria, wherein the ACK includes an indication that the first smart contract is accepted;
sending a modified first smart contract when the first smart contract is conditionally accepted;
receiving a notification that the first smart contract or the modified first smart contract is recorded in a distributed ledger system via a distributed ledger service (DLS); and
executing the first task when the first task is or accepted or is conditionally accepted.

2. The method of claim 1, further comprising confirming a validation status of the first smart contract with the DLS prior to executing the first task.

3. The method of claim 1, wherein the instructions for executing the first task include one or more of: a first task identifier, a generic operation type (GOT), a GOT subtype, first task execution guidelines, description of the first task complexity, an indication of whether the first task can be stopped and replaced while the first task is being executed, and first task execution triggers.

4. The method of claim 3, wherein the set of trust evaluation criteria specifies one or more: types of trust indicators considered, algorithms adopted for calculating respective types of trust indicators and a corresponding trust index, and parameter value configurations.

5. The method of claim 1, further comprising analyzing terms of the first smart contract, wherein the terms of the first smart contract include one or more of: an identifier of the first task, an identifier of the second entity, a corresponding distributed ledger account and/or address of the second entity, and identifier of the first entity, a corresponding distributed ledger account and/or address of the first entity, specific execution instructions for the first task, a set trust evaluation criteria adopted, the expected trust level specified by the first entity, and clauses, terms, policies of the first smart contract.

6. The method of claim 1, further comprising
determining there are insufficient resources for executing the first task;
identifying one or more ongoing second tasks corresponding to a second smart contract with a third entity that may be replaced by the first task;
sending a task replacement proposal to the second entity;
receiving a task replacement notification from the third entity, the task replacement indicating that a third smart contract is established between the second entity and the third entity;
requesting, from the DLS, a validation that the second smart contract is terminated and the third smart is in effect;
confirming the task replacement with the second entity and sending an updated first smart contract to the second entity;
receiving an ACK from the second entity confirming task replacement;
sending a finalized first smart contract to the DLS for recording;
receiving, from the DLS, an ACK that the finalized first smart contract is recorded; and
ending the second task with the third entity and performing the first task with the second entity using resources previously-allocated to second task.

7. The method according to claim 1, further comprising
determining the first task should be migrated to a fourth entity;
sending a task migration alert to the second entity;
receiving an ACK of the task migration alert;
receiving, from the second entity, a request to migrate the first task to the fourth entity; and
migrating the first task to the fourth entity.

8. The method according to claim 1, wherein first entity is a wireless transmit/receive unit (WTRU), a network element, a smart device, or an internet of things (IoT) device, and wherein the second entity is a UE, WTRU, network element, smart device, or IoT device hosting a software application or storing executable instructions which cause a specific task to be performed.

9. The method according to claim 6, wherein the third entity is a UE, WTRU, network element, smart device, or IoT device hosting a software application or storing executable instructions which cause a specific task to be performed.

10. The method according to claim 7, wherein the fourth entity is a UE, WTRU, network element, smart device, or IoT device hosting a software application or storing executable instructions which cause a specific task to be performed.

11. A method implemented in a second entity, the method comprising:
generating task execution instructions for a first task;
determining at least one of a set of trust evaluation criteria and an expected trust level to be achieved;
sending a first task assignment request to a first entity, the first task assignment including one or more of: an identifier of the first task, an identifier of the first entity, an identifier of the second entity, the execution instructions for the first task, a set of trust evaluation criteria adopted, a trust level specified by the second entity, a first smart contract, and a preferred DLS;
receiving an acknowledgement (ACK) from the first entity that the first task is accepted, conditionally accepted, or rejected;
sending a trust evaluation request to a trust evaluation service (TES) to evaluate a trust of the first entity to perform at least the first task when the first task is conditionally accepted or accepted;
receiving an ACK from the TES, the ACK including a trust index; and
deciding to allow the first entity to continue execution of the first task or to terminate execution of the first task based on the trust index.

12. The method of claim 11, further comprising:
sending a first smart contract deployment request to a distributed ledger service (DLS) including a finalized first smart contract when the first entity and the second entity agree to the finalized first smart contract;
receiving an acknowledgement (ACK) from the DLS; and
sending, to the first entity a notification indicating a successful recording of the first smart contract.

13. The method of claim 11, wherein the first task execution instructions include one or more of: a first task identifier, at least one generic operation type (GOT), at least one GOT subtype, execution guidelines, a description of task complexity, an indication of whether a task can be stopped and replaced while a first entity is executing a task, and task execution triggers.

14. The method of claim 13, wherein the set of trust evaluation criteria specifies one or more of: type of trust indicator (TIDC) for performing the first task, algorithms adopted for calculating a trust index (TIndex) of respective type of TIDC and a specified trust level.

15. The method of claim 12, wherein the first smart contract includes one or more of: an identifier of the first task, an identifier of the second entity, a corresponding distributed ledger account and/or address of the second entity, and identifier of the first entity, a corresponding distributed ledger account and/or address of the first entity, specific task instructions for the first task, a set trust evaluation criteria adopted, a trust level specified by the second entity, and clauses, terms, and policies specified for the first task.

16. The method of claim 12, further comprising:
receiving a task replacement proposal request from the first entity when the first entity is executing a second task with a third entity, has a second smart contract corresponding to the second task stored in the DLS, and does not have sufficient resources for the execution of the first task or continued execution of the first task;
deciding to establish a task replacement with the third entity;
generating a third smart contract to replace the second task with the first task;
sending a task replacement initiation request including the third smart contract to the third entity;
receiving, from the third entity, an ACK of the task replacement initiation request and an agreement to accept the task replacement; and
receiving, from the first entity, a notification of task replacement complete.

17. The method of claim 12, further comprising:
receiving a task migration request from the first entity when determining it cannot provide sufficient resources for the first task;
sending an ACK of the task migration request;
sending a migration destination entity identification request to a third entity;
receiving a list of destination entity candidates from the third entity;
selecting a fourth entity from the list of destination entity candidates to migrate the first task;
sending a request to the fourth entity to accept the migration of the first task; and
sending a migration request to the first entity to migrate the first task to the fourth entity after the fourth entity agrees to accept the migration of the first task.

18. The method according to claim 11, wherein the first entity is a wireless transmit/receive unit (WTRU), a network element, a smart device, or an internet of things (IoT) device.

19. The method according to claim 11, wherein the second entity is a UE, WTRU, network element, smart device, or IoT device hosting a software application or storing executable instructions which cause a specific task to be performed.
